(19) United States
(12) Patent Application Publication
(10) Pub. No.: US 2022/0029688 A1
(43) Pub. Date: Jan. 27, 2022

(54) SWITCHING BETWEEN BEAMFORMING MODES

(71) Applicant: QUALCOMM Incorporated, San Diego, CA (US)

(72) Inventors: Hamed PEZESHKI, San Diego, CA (US); Tao LUO, San Diego, CA (US); Arumugam CHENDAMARAI KANNAN, San Diego, CA (US)

(21) Appl. No.: 17/443,220

(22) Filed: Jul. 22, 2021

Related U.S. Application Data
(60) Provisional application No. 62/705,994, filed on Jul. 24, 2020.
(60) Provisional application No. 62/705,987, filed on Jul. 24, 2020.
(60) Provisional application No. 62/705,986, filed on Jul. 24, 2020.

(51) Int. Cl. H04B 7/06; H04L 1/00; H04W 72/12

(52) U.S. Cl. CPC H04B 7/0686; H04W 72/1263; H04L 1/0017; H04B 7/0617

(57) ABSTRACT

Various aspects of the present disclosure generally relate to wireless communication. In some aspects, a user equipment may determine to switch from a first beamforming mode to a second beamforming mode, wherein one of the first beamforming mode and the second beamforming mode is a digital beamforming mode, and wherein the other of the first beamforming mode and the second beamforming mode is an at least partially analog beamforming mode; and perform a communication using the second beamforming mode. Numerous other aspects are provided.

### CROSS-REFERENCE TO RELATED APPLICATION

This patent application claims priority to U.S. Provisional Patent Application No. 62/705,994, filed on Jul. 24, 2020, entitled “TRIGGERING CONDITION FOR SWITCHING BETWEEN BEAMFORMING MODES,” U.S. Provisional Patent Application No. 62/705,987, filed on Jul. 24, 2020, entitled “DYNAMIC INDICATIONS OF BEAMFORMING MODES FOR SETS OF COMMUNICATIONS,” and U.S. Provisional Patent Application No. 62/705,986, filed on Jul. 24, 2020, entitled “MAPPING OF BEAMFORMING MODES TO BANDWIDTH PARTS,” all of which are assigned to the assignee hereof. The disclosures of the prior applications are considered part of and are incorporated by reference into this patent application.

### FIELD OF THE DISCLOSURE

Aspects of the present disclosure generally relate to wireless communication and to techniques and apparatuses for a triggering condition for switching between beamforming modes.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication, performed by a user equipment (UE), may include determining to switch from a first beamforming mode to a second beamforming mode, wherein one of the first beamforming mode and the second beamforming mode is a digital beamforming mode, and wherein the other of the first beamforming mode and the second beamforming mode is an at least partially analog beamforming mode; and performing a communication using the second beamforming mode.

In some aspects, a method of wireless communication, performed by a base station, may include determining that a UE is to switch from a first beamforming mode to a second beamforming mode, wherein one of the first beamforming mode and the second beamforming mode is a digital beamforming mode, and wherein the other of the first beamforming mode and the second beamforming mode is an at least partially analog beamforming mode; and transmitting, to the UE and based at least in part on determining that the UE is to switch from the first beamforming mode to the second beamforming mode, configuration information configuring the UE to switch from the first beamforming mode to the second beamforming mode.

In some aspects, a UE for wireless communication may include a memory and one or more processors coupled to the memory. The memory and the one or more processors may be configured to determine to switch from a first beamforming mode to a second beamforming mode, wherein one of the first beamforming mode and the second beamforming mode is a digital beamforming mode, and wherein the other of the first beamforming mode and the second beamforming mode is an at least partially analog beamforming mode; and perform a communication using the second beamforming mode.

In some aspects, a base station for wireless communication may include a memory and one or more processors coupled to the memory. The memory and the one or more processors may be configured to determine that a UE is to switch from a first beamforming mode to a second beamforming mode, wherein one of the first beamforming mode and the second beamforming mode is a digital beamforming mode, and wherein the other of the first beamforming mode and the second beamforming mode is an at least partially analog beamforming mode; and transmit, to the UE and based at least in part on determining that the UE is to switch from the first beamforming mode to the second beamforming mode, configuration information configuring the UE to switch from the first beamforming mode to the second beamforming mode.

In some aspects, a non-transitory computer-readable medium may store one or more instructions for wireless communication. The one or more instructions, when executed by one or more processors of a UE, may cause the one or more processors to determine to switch from a first beamforming mode to a second beamforming mode, wherein one of the first beamforming mode and the second beamforming mode is a digital beamforming mode, and wherein the other of the first beamforming mode and the second beamforming mode is an at least partially analog beamforming mode; and perform a communication using the second beamforming mode.

In some aspects, a non-transitory computer-readable medium may store one or more instructions for wireless communication. The one or more instructions, when executed by one or more processors of a base station, may cause the one or more processors to determine that a UE is to switch from a first beamforming mode to a second beamforming mode, wherein one of the first beamforming mode and the second beamforming mode is a digital beamforming mode, and wherein the other of the first beamforming mode and the second beamforming mode is an at least partially analog beamforming mode; and transmit, to the UE and based at least in part on determining that the UE is to switch from the first beamforming mode to the second beamforming mode, configuration information configuring the UE to switch from the first beamforming mode to the second beamforming mode.

In some aspects, an apparatus for wireless communication may include means for determining to switch from a first beamforming mode to a second beamforming mode, wherein one of the first beamforming mode and the second beamforming mode is a digital beamforming mode, and wherein the other of the first beamforming mode and the second beamforming mode is an at least partially analog beamforming mode; and means for performing a communication using the second beamforming mode.

In some aspects, an apparatus for wireless communication may include means for determining that a UE is to switch from a first beamforming mode to a second beamforming mode, wherein one of the first beamforming mode and the second beamforming mode is a digital beamforming mode, and wherein the other of the first beamforming mode and the second beamforming mode is an at least partially analog beamforming mode; and means for transmitting, to the UE and based at least in part on determining that the UE is to switch from the first beamforming mode to the second beamforming mode, configuration information configuring the UE to switch from the first beamforming mode to the second beamforming mode.

In some aspects, a method of wireless communication, performed by a UE, may include receiving configuration information that indicates a mapping of one or more bandwidth parts to a set of beamforming modes of the UE; and receiving, via a bandwidth part of the one or more bandwidth parts, a downlink communication using a beamforming mode, of the set of beamforming modes of the UE, that is mapped to the bandwidth part based at least in part on the configuration information.

In some aspects, a method of wireless communication, performed by a base station, may include transmitting configuration information that indicates a mapping of one or more bandwidth parts to a set of beamforming modes of a UE; and transmitting, via a bandwidth part of the one or more bandwidth parts, a downlink communication based at least in part on the UE using a beamforming mode, of the set of beamforming modes of the UE, that is mapped to the bandwidth part based at least in part on the configuration information.

In some aspects, a non-transitory computer-readable medium may store one or more instructions for wireless communication. The one or more instructions, when executed by one or more processors of a UE, may cause the one or more processors to receive configuration information that indicates a mapping of one or more bandwidth parts to a set of beamforming modes of the UE; and receive, via a bandwidth part of the one or more bandwidth parts, a downlink communication using a beamforming mode, of the set of beamforming modes of the UE, that is mapped to the bandwidth part based at least in part on the configuration information.

In some aspects, a non-transitory computer-readable medium may store one or more instructions for wireless communication. The one or more instructions, when executed by one or more processors of a base station, may cause the one or more processors to transmit configuration information that indicates a mapping of one or more bandwidth parts to a set of beamforming modes of a UE; and transmit, via a bandwidth part of the one or more bandwidth parts, a downlink communication based at least in part on the UE using a beamforming mode, of the set of beamforming modes of the UE, that is mapped to the bandwidth part based at least in part on the configuration information.

In some aspects, a user equipment for wireless communication may include a memory and one or more processors coupled to the memory. The memory and the one or more processors may be configured to receive configuration information that indicates a mapping of one or more bandwidth parts to a set of beamforming modes of the UE; and receive, via a bandwidth part of the one or more bandwidth parts, a downlink communication using a beamforming mode, of the set of beamforming modes of the UE, that is mapped to the bandwidth part based at least in part on the configuration information.

In some aspects, a base station for wireless communication may include a memory and one or more processors coupled to the memory. The memory and the one or more processors may be configured to transmit configuration information that indicates a mapping of one or more bandwidth parts to a set of beamforming modes of a UE; and transmit, via a bandwidth part of the one or more bandwidth parts, a downlink communication based at least in part on the UE using a beamforming mode, of the set of beamforming modes of the UE, that is mapped to the bandwidth part based at least in part on the configuration information.

In some aspects, an apparatus for wireless communication may include means for receiving configuration information that indicates a mapping of one or more bandwidth parts to a set of beamforming modes of the apparatus; and means for receiving, via a bandwidth part of the one or more bandwidth parts, a downlink communication using a beamforming mode, of the set of beamforming modes of the apparatus, that is mapped to the bandwidth part based at least in part on the configuration information.

In some aspects, an apparatus for wireless communication may include means for transmitting configuration information that indicates a mapping of one or more bandwidth parts to a set of beamforming modes of a UE; and means for transmitting, via a bandwidth part of the one or more bandwidth parts, a downlink communication based at least in part on the UE using a beamforming mode, of the set of beamforming modes of the UE, that is mapped to the bandwidth part based at least in part on the configuration information.

In some aspects, a method of wireless communication performed by a UE includes receiving an indication of a beamforming mode, of a set of candidate beamforming modes, to use for transmitting a set of uplink communications or receiving a set of downlink communications; and transmitting the set of uplink communications or receiving the set of downlink communications based at least in part on the indication of the beamforming mode.

In some aspects, a method of wireless communication performed by a base station includes transmitting an indication of a beamforming mode, of a set of candidate beamforming modes, for a UE to use for transmitting a set of uplink communications or receiving a set of downlink communications; and receiving the set of uplink communications or transmitting the set of downlink communications based at least in part on the indication of the beamforming mode.

In some aspects, a non-transitory computer-readable medium storing a set of instructions for wireless communication includes one or more instructions that, when executed by one or more processors of a UE, cause the UE to: receive an indication of a beamforming mode, of a set of candidate beamforming modes, to use for transmitting a set of uplink communications or receiving a set of downlink communications; and transmit the set of uplink communications or receive the set of downlink communications based at least in part on the indication of the beamforming mode.

In some aspects, a non-transitory computer-readable medium storing a set of instructions for wireless communication includes one or more instructions that, when executed by one or more processors of a base station, cause the base station to: transmit an indication of a beamforming mode, of a set of candidate beamforming modes, for a UE to use for transmitting a set of uplink communications or receiving a set of downlink communications; and receive the set of uplink communications or transmit the set of downlink communications based at least in part on the indication of the beamforming mode.

In some aspects, a UE for wireless communication includes a memory and one or more processors coupled to the memory, the memory and the one or more processors configured to: receive an indication of a beamforming mode, of a set of candidate beamforming modes, to use for transmitting a set of uplink communications or receiving a set of downlink communications; and transmit the set of uplink communications or receive the set of downlink communications based at least in part on the indication of the beamforming mode.

In some aspects, a base station for wireless communication includes a memory and one or more processors coupled to the memory, the memory and the one or more processors configured to: transmit an indication of a beamforming mode, of a set of candidate beamforming modes, for a UE to use for transmitting a set of uplink communications or receiving a set of downlink communications; and receive the set of uplink communications or transmit the set of downlink communications based at least in part on the indication of the beamforming mode.

In some aspects, an apparatus for wireless communication includes means for receiving an indication of a beamforming mode, of a set of candidate beamforming modes, to use for transmitting a set of uplink communications or receiving a set of downlink communications; and means for transmitting the set of uplink communications or receiving the set of downlink communications based at least in part on the indication of the beamforming mode.

In some aspects, an apparatus for wireless communication includes means for transmitting an indication of a beamforming mode, of a set of candidate beamforming modes, for a UE to use for transmitting a set of uplink communications or receiving a set of downlink communications; and means for receiving the set of uplink communications or transmitting the set of downlink communications based at least in part on the indication of the beamforming mode.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency chains, power amplifiers, modulators, buffers, processors, interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a UE in a wireless network, in accordance with the present disclosure.

FIGS. 3 and 4 are diagrams illustrating one or more examples of beamforming architectures that support beamforming for millimeter wave communications, in accordance with the present disclosure.

FIGS. 5 and 6 are a diagrams illustrating examples of switching beamforming modes based at least in part on a trigger condition, in accordance with the present disclosure.

FIGS. 7 and 8 are diagrams illustrating example processes associated with a triggering condition for switching between beamforming modes, in accordance with the present disclosure.

FIGS. 9 and 10 are diagrams illustrating example processes associated with switching between beamforming modes, in accordance with the present disclosure.

FIGS. 11 and 12 are diagrams illustrating example processes associated with switching between beamforming modes, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

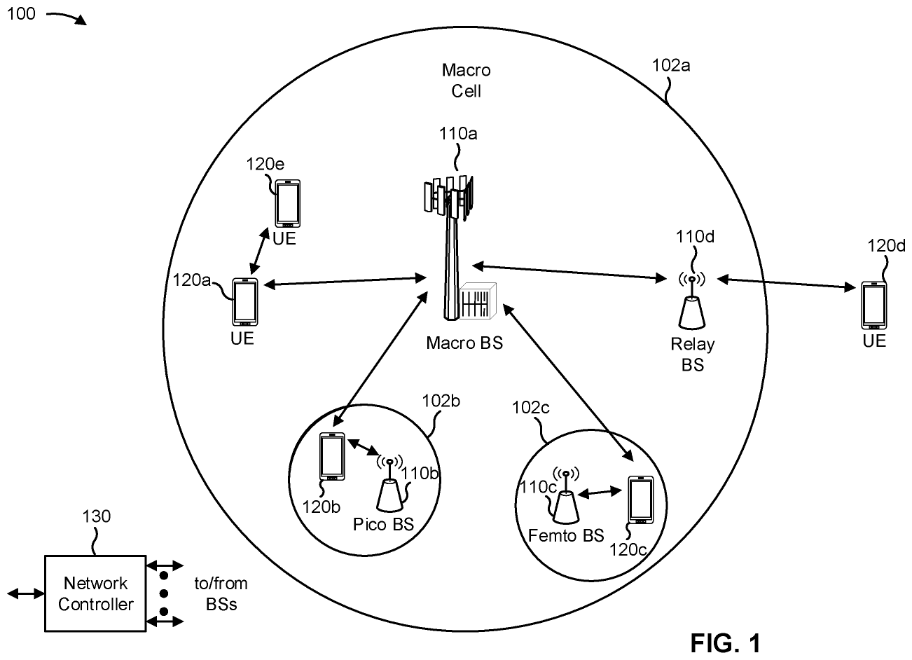

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. ABS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, directly or indirectly, via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

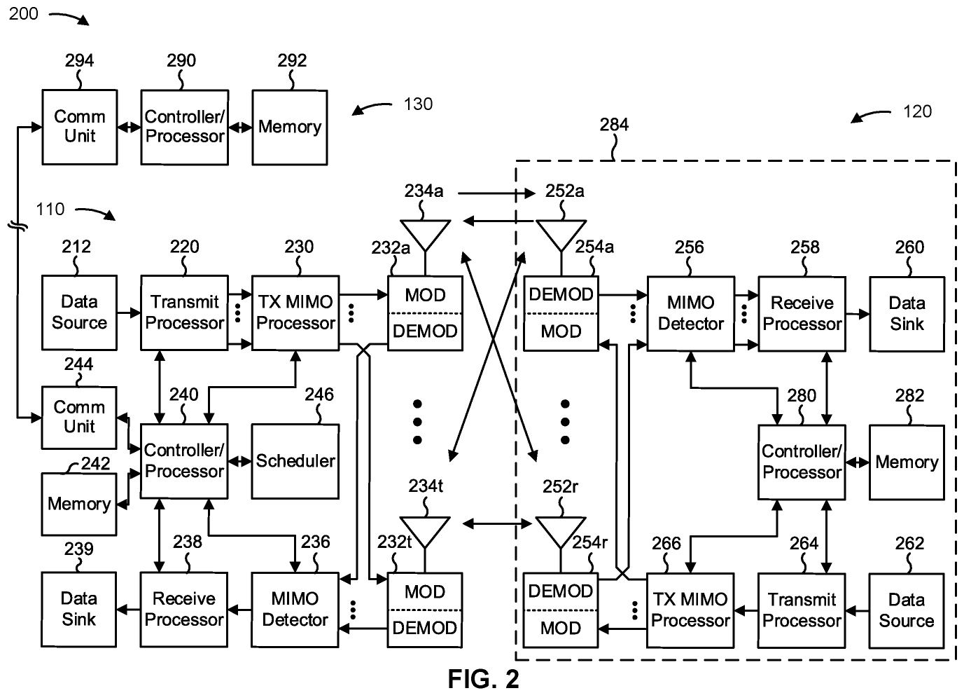

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a channel quality indicator (CQI) parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

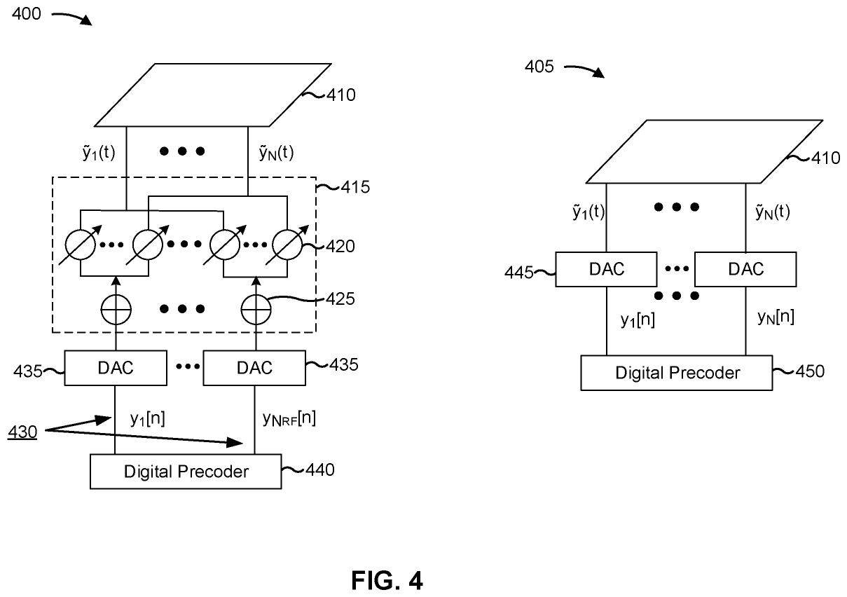

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 4-6).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 4-6).

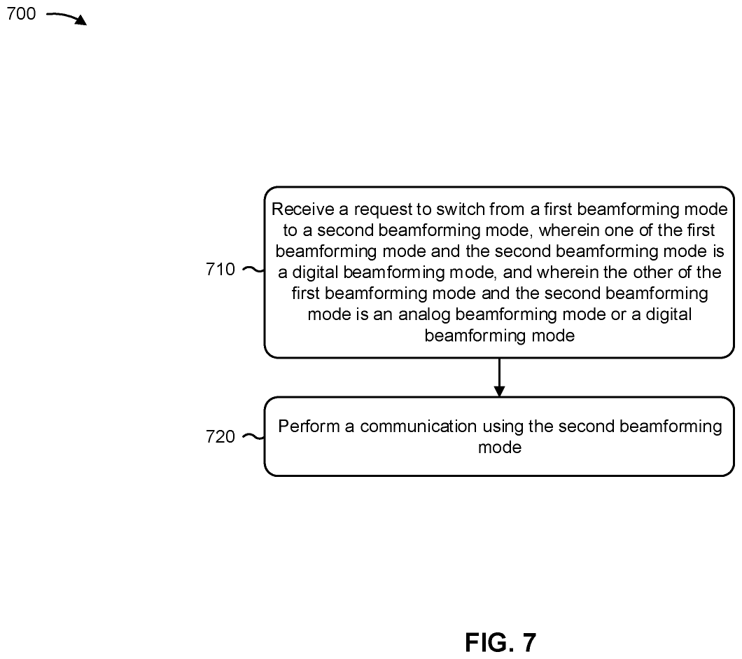

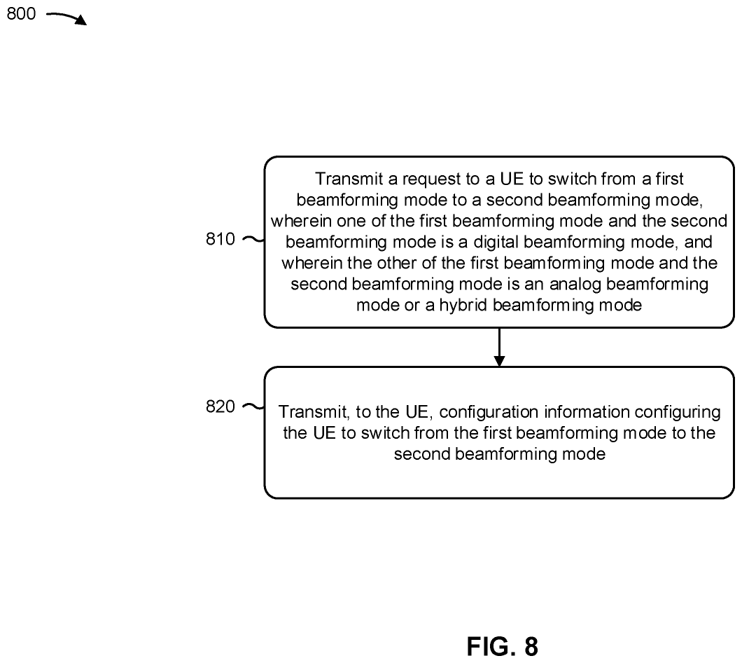

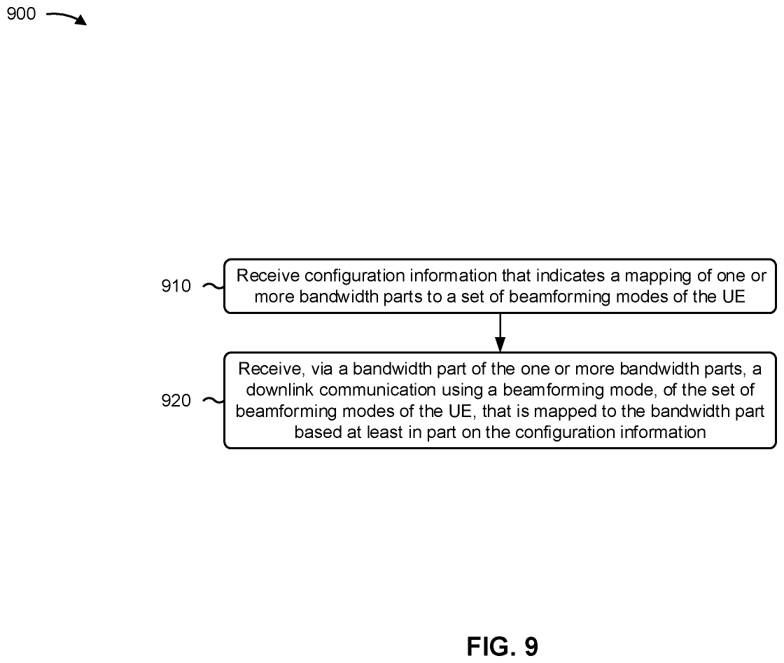

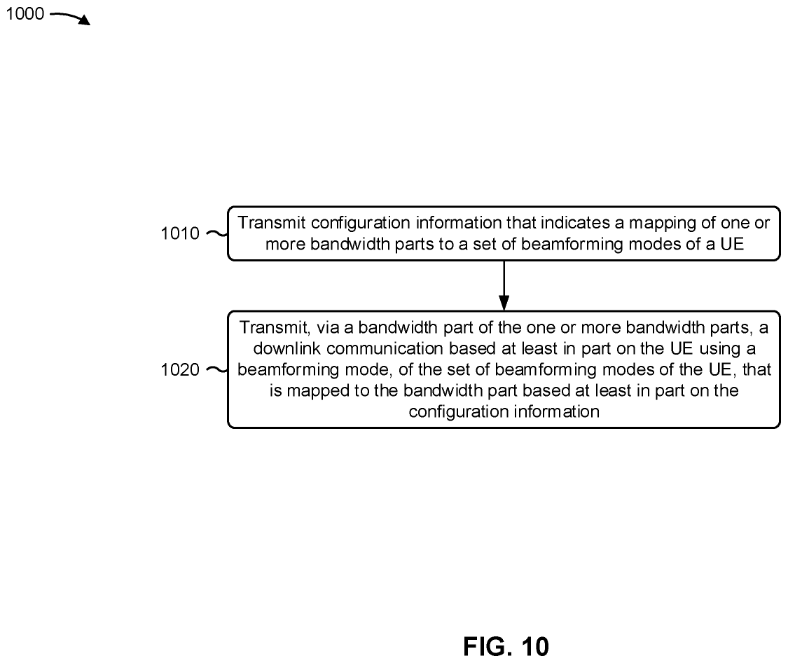

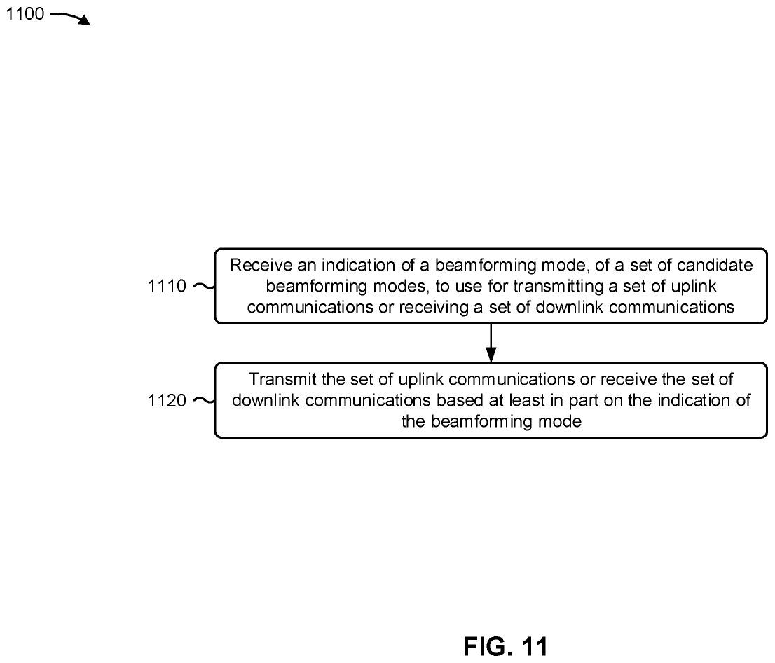

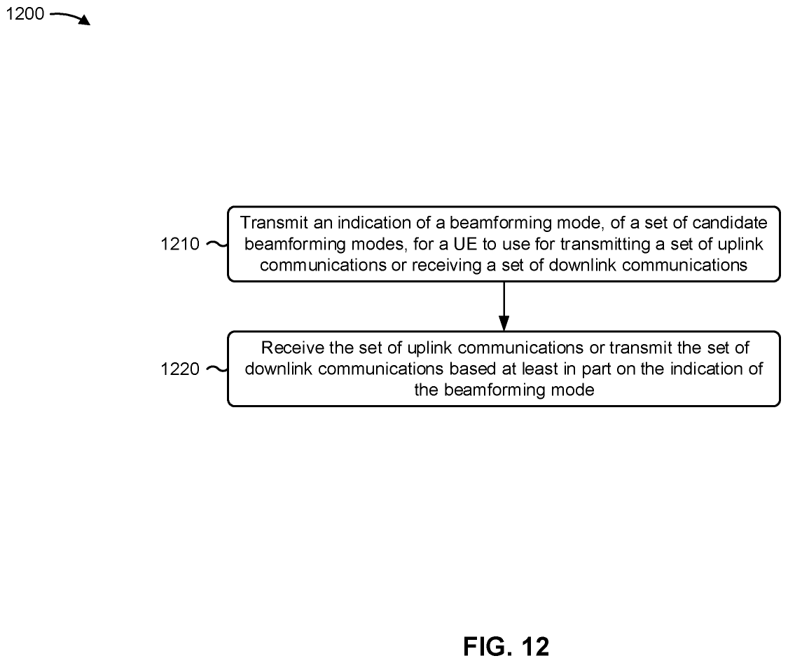

Controller/processor 240 of base station 110, controller/processor 280 of UE 120, and/or any other component(s) of FIG. 2 may perform one or more techniques associated with a triggering condition for switching between beamforming modes, as described in more detail elsewhere herein. For example, controller/processor 240 of base station 110, controller/processor 280 of UE 120, and/or any other component(s) of FIG. 2 may perform or direct operations of, for example, process 700 of FIG. 7, process 800 of FIG. 8, process 900 of FIG. 9, process 1000 of FIG. 10, process 1100 of FIG. 11, process 1200 of FIG. 12, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, process 900 of FIG. 9, process 1000 of FIG. 10, process 1100 of FIG. 11, process 1200 of FIG. 12, and/or other processes as described herein. In some aspects, executing instructions may include running the instructions, converting the instructions, compiling the instructions, and/or interpreting the instructions, among other examples.

In some aspects, UE 120 may include means for determining to switch from a first beamforming mode to a second beamforming mode, wherein one of the first beamforming mode and the second beamforming mode is a digital beamforming mode, and wherein the other of the first beamforming mode and the second beamforming mode is an at least partially analog beamforming mode; means for performing a communication using the second beamforming mode, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, base station 110 may include means for determining that a UE is to switch from a first beamforming mode to a second beamforming mode, wherein one of the first beamforming mode and the second beamforming mode is a digital beamforming mode, and wherein the other of the first beamforming mode and the second beamforming mode is an at least partially analog beamforming mode; means for transmitting, to the UE and based at least in part on determining that the UE is to switch from the first beamforming mode to the second beamforming mode, configuration information configuring the UE to switch from the first beamforming mode to the second beamforming mode; and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

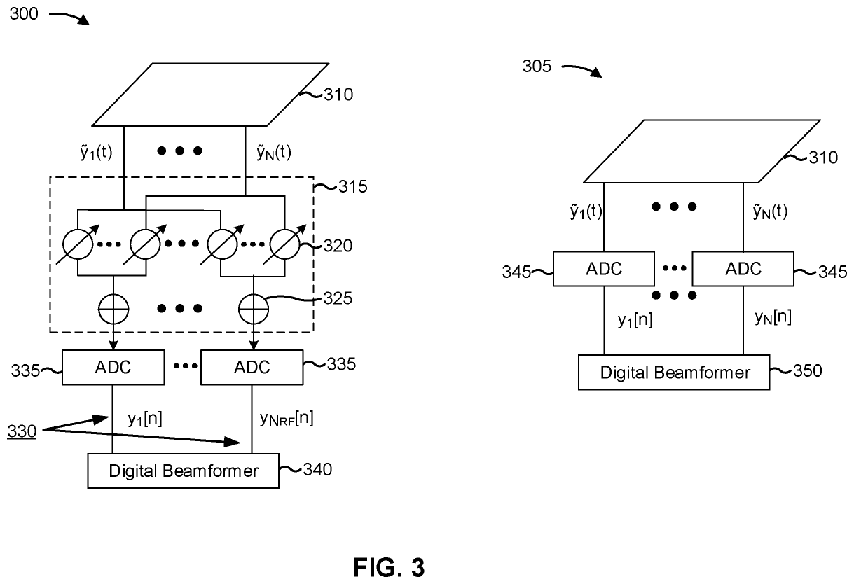

FIG. 3 is a diagram illustrating examples of beamforming architectures 300 and 305 that support beamforming for millimeter wave communications, in accordance with the present disclosure. In some aspects, architecture 300 and/or 305 may implement aspects of wireless network 100. In some aspects, architectures 300 and/or 305 may be implemented in a receiving device (e.g., a wireless communication device, UE, or base station), as described herein. For example, the architectures 300 and 305 may show receive chains (e.g., radio frequency (RF) chains) for reception of communications by a receiving device. The architectures 300 and 305, and the architectures 400 and 405, may be particularly useful for communication in a millimeter wave range, such as FR2 and/or the like.

Broadly, FIG. 3 is a diagram illustrating example hardware components of a wireless communication device in accordance with certain aspects of the disclosure. The illustrated components may include those that may be used for antenna element selection and/or for beamforming for reception of wireless signals. There are numerous architectures for antenna element selection and implementing phase shifting, only two examples of which are illustrated here. Transmission lines or other waveguides, wires, traces, and/or the like are shown connecting the various components to illustrate how signals to be transmitted may travel between components.

Architecture 300 includes a hybrid beamforming architecture. Architecture 305 includes a fully digital beamforming architecture. The architectures 300 and 305 include an antenna array 310. The antenna array 310 may include N antenna elements (not shown). An antenna element may include one or more sub-elements for radiating or receiving RF signals. For example, a single antenna element may include a first sub-element cross-polarized with a second sub-element that can be used to independently transmit or receive cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

A signal \tilde{y}ₙ(t) received at an antenna n at a time t may propagate to an analog portion 315 of the architecture 300. The analog portion 315 may include a plurality of phase shifters 320 and one or more amplifiers 325 (e.g., one amplifier 325 per RF chain, multiple amplifiers 325 per RF chain, or one amplifier 325 for multiple RF chains).

The architecture 300 includes a plurality of RF chains 330 (e.g., N_{RF} RF chains). N_{RF} may be smaller than N (e.g., the number of RF chains 330 may be smaller than the number of antenna elements of the architecture 300). In some examples, N_{RF} may be 2 or 4, or another number, such as 6. If N_{RF}=N, then the architecture 300 would be a digital beamforming architecture (as shown by reference number 305). An architecture including a plurality of RF chains 330 and analog phase shifters and amplifiers may be referred to as a hybrid beamforming architecture. An architecture including a single RF chain (e.g., N_{RF}=1), or an architecture including two RF chains corresponding to different polarizations, may be referred to as an analog beamforming architecture. An architecture 305 including a digital beamformer without analog phase shifters and amplifiers may be referred to as a digital beamforming architecture or a digital-only beamforming architecture.

Each RF chain 330 of architecture 300 may be associated with a respective analog-to-digital converter (ADC) 335. The ADCs 335 of the RF chains 330 may perform analog-to-digital conversion of the signals received from the analog portion 315. The ADCs 335 may provide digital signals y₁ [n] through y_{N}_{_{RF}} [n] to a digital beamformer 340. The digital beamformer 340 may be implemented at the baseband or may interface with a baseband processor. The digital beamformer 340 may perform digital-domain signal processing, such as digital baseband processing, controlling operation of components 310/315/320/325/335, spatial configuration of the communication of the wireless communication device, and so on.

The architecture 305 omits the analog portion 315 (e.g., the phase shifters 320, the amplifiers 325, and so on). As shown, the architecture 305 provides an ADC 345 per antenna element (e.g., N ADCs 345 for the N antenna elements). The wireless communication device may receive signals via antenna elements of the antenna array 310, provide the signals to the ADCs 345, convert the signals to the digital domain, then process the signals by the digital beamformer 350. In the architecture 305, the digital beamformer 350 handles phase shifting, mixing, and/or other operations handled by the analog portion 315 of the architecture 300.

In some aspects, an ADC 335/345 may be associated with a bit granularity. An ADC 335/345 may receive an analog signal, which is generally not quantized, and may output a digital signal that is quantized in accordance with the bit granularity. For example, a 4-bit ADC may output a 4-bit quantization of a signal, whereas an 8-bit ADC may output an 8-bit quantization of a signal. Generally, higher-bit-granularity ADCs (e.g., 8-bit ADCs) are associated with a larger baseband processing burden and higher power consumption than lower-bit-granularity ADCs (e.g., 3-bit or 4-bit ADCs).

The digital beamforming architecture 305 may provide increased flexibility for spatial signal processing relative to the hybrid beamforming architecture 300, which may facilitate maximum ratio combining, individual adjustment of antenna phase, and so on. However, at a given bit granularity of ADC, the increased number of ADCs 345 associated with the digital beamforming architecture 305 may create a significantly heavier processing and power burden at the digital beamformer 350 than at the digital beamformer 340 of the hybrid beamforming architecture 300. For example, the hybrid beamforming architecture 300 may be expected to have N_{RF} ADCs 335, whereas the digital beamforming architecture 305 may be expected to have N ADCs 345. To mitigate this processing and power burden, some digital beamforming architectures 300 may use ADCs with a lower bit granularity than an ADC 335. For example, a 3-bit or 4-bit granularity for ADC 345 may reduce baseband processing load and power consumption relative to an 8-bit granularity for ADC 345, and may still provide performance benefits over some hybrid beamforming architectures 300, even those associated with higher ADC bit granularities, such as 8 bits. It should be noted that the techniques described herein can be applied for hybrid beamforming architectures as well as digital beamforming architectures.

A wireless communication device may be implemented with architecture 300 and/or architecture 305. The wireless communication device may be configured to use one of a set of architectures for communicating with a base station. However, a static selection of a single architecture may limit benefits of having the wireless communication device implemented with multiple architectures. In some aspects, static selection of the single architecture may consume computing, communication, network, and/or power resources by using the single architecture to transmit and/or receive communications. For example, the single architecture may be efficient (e.g., use an appropriate spectral efficiency, resolution, and/or power consumption and/or the like) for a first set of communications and another architecture may be efficient for a second set of communications.

As indicated above, FIG. 3 is provided as an example. Other examples may differ from what is described with regard to FIG. 3.

FIG. 4 is a diagram illustrating examples of beamforming architectures 400 and 405 that support beamforming for millimeter wave communications, in accordance with the present disclosure. In some aspects, architecture 400 and/or 405 may implement aspects of wireless network 100. In some aspects, architectures 400 and/or 405 may be implemented in a transmitting device (e.g., a wireless communication device, UE, or base station), as described herein. For example, the architectures 400 and 405 may show transmission chains (e.g., radio frequency (RF) chains) for transmission of communications by a transmitting device.

FIG. 4 is a diagram illustrating example hardware components of a wireless communication device in accordance with certain aspects of the disclosure. The illustrated components may include those that may be used for antenna element selection and/or for beamforming for transmission of wireless signals. There are numerous architectures for antenna element selection and implementing phase shifting, only two examples of which are illustrated here. Transmission lines or other waveguides, wires, traces, and/or the like are shown connecting the various components to illustrate how signals to be transmitted may travel between components.

Architecture 400 includes a hybrid beamforming architecture. Architecture 405 includes a fully digital beamforming architecture. The architectures 400 and 405 include an antenna array 410. The antenna array 410 may include N antenna elements (not shown). An antenna element may include one or more sub-elements for radiating or receiving RF signals. For example, a single antenna element may include a first sub-element cross-polarized with a second sub-element that can be used to independently transmit or receive cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

A signal \tilde{y}ₙ(t) to be transmitted at an antenna n at a time t may propagate to the antenna n via an analog portion 415 of the architecture 400. The analog portion 415 may include a plurality of phase shifters 420 and one or more amplifiers 425 (e.g., one amplifier 425 per RF chain, multiple amplifiers 425 per RF chain, or one amplifier 425 for multiple RF chains).

The architecture 400 includes a plurality of RF chains 430 (e.g., N_{RF} RF chains). N_{RF} may be smaller than N (e.g., the number of RF chains 430 may be smaller than the number of antenna elements of the architecture 400). In some examples, N_{RF} may be 2 or 4, or another number, such as 6. If N_{RF}=N, then the architecture 400 would be a digital beamforming architecture (as shown by reference number 405). An architecture including a plurality of RF chains 430 and analog phase shifters and amplifiers may be referred to as a hybrid beamforming architecture. An architecture including a single RF chain (e.g., N_{RF}=1), or an architecture including two RF chains corresponding to different polarizations, may be referred to as an analog beamforming architecture. An architecture 405 including a digital beamformer without analog phase shifters and amplifiers may be referred to as a digital beamforming architecture or a digital-only beamforming architecture.

Each RF chain 430 of architecture 400 may be associated with a respective digital-to-analog converter (DAC) 435. The DACs 435 of the RF chains 430 may perform digital-to-analog conversion of the signals before providing the signals to the analog portion 415. The DACs 435 may receive digital signals y₁ [n] through y_{N}_{_{RF}} [n] from a digital precoder 440. The digital precoder 440 may be implemented at the baseband or may interface with a baseband processor. The digital precoder 440 may perform digital-domain signal processing, such as digital baseband processing, controlling operation of components 410/415/420/425/435, spatial configuration of the communication of the wireless communication device, and so on.

The architecture 405 omits the analog portion 415 (e.g., the phase shifters 420, the amplifiers 425, and so on). As shown, the architecture 405 provides a DAC 445 per antenna element (e.g., N DACs 445 for the N antenna elements). The wireless communication device may transmit signals via antenna elements of the antenna array 410, as received via the DACs 445. The. DACs 445 may convert the signals to the analog domain from the digital domain, as received from the digital precoder 450. In the architecture 405, the digital precoder 450 handles phase shifting, mixing, and/or other operations handled by the analog portion 415 of the architecture 400.

In some aspects, an DAC 435/445 may be associated with a bit granularity. A DAC 435/445 may receive a digital signal, which is generally quantized according to the bit granularity, and may output an analog signal that is not quantized. For example, a 4-bit DAC may receive a 4-bit quantization of a signal, whereas an 8-bit DAC may receive an 8-bit quantization of a signal. Generally, higher-bit-granularity DACs (e.g., 8-bit DACs) are associated with a larger baseband processing burden and higher power consumption than lower-bit-granularity DACs (e.g., 3-bit or 4-bit DACs).

The digital beamforming architecture 405 may provide increased flexibility for spatial signal processing relative to the hybrid beamforming architecture 400, which may facilitate maximum ratio combining, individual adjustment of antenna phase, and so on. However, at a given bit granularity of DAC, the increased number of DACs 445 associated with the digital beamforming architecture 405 may create a significantly heavier processing and power burden at the digital precoder 450 than at the digital precoder 440 of the hybrid beamforming architecture 400. For example, the hybrid beamforming architecture 400 may be expected to have N_{RF} DACs 435 whereas the digital beamforming architecture 405 may be expected to have N_{RF} DACs 445. To mitigate this processing and power burden, some digital beamforming architectures 400 may use DACs with a lower bit granularity than a DAC 435. For example, a 3-bit or 4-bit granularity for DAC 445 may reduce baseband processing load and power consumption relative to an 8-bit granularity for DAC 445, and may still provide performance benefits over some hybrid beamforming architectures 400, even those associated with higher DAC bit granularities, such as 8 bits. It should be noted that the techniques described herein can be applied for hybrid beamforming architectures as well as digital beamforming architectures.

A wireless communication device may be implemented with architecture 400 and/or architecture 405. The wireless communication device may be configured to use one of a set of architectures for communicating with a base station. However, a static selection of a single architecture may limit benefits of having the wireless communication device implemented with multiple architectures. In some aspects, static selection of the single architecture may consume computing, communication, network, and/or power resources by using the single architecture to transmit and/or receive communications. For example, the single architecture may be efficient (e.g., use an appropriate spectral efficiency, resolution, and/or power consumption and/or the like) for a first set of communications and another architecture may be efficient for a second set of communications.

As indicated above, FIG. 4 is provided as an example. Other examples may differ from what is described with regard to FIG. 4.

A UE may be associated with a digital beamforming architecture and a hybrid or analog (hybrid/analog) beamforming architecture. For example, the UE may support a hybrid/analog beamforming mode, in which the UE receives and processes communications using the architecture 300/400 of FIGS. 3 and 4, and a digital beamforming mode, in which the UE receives communications using the architecture 305/405 of FIGS. 3 and 4. In some circumstances, operating conditions of the UE may mean that a given beamforming mode is less viable or efficient than an alternative beamforming mode. For example, a digital beamforming mode may perform better in conditions of high signal to interference plus noise ratio (SINR), whereas a hybrid/analog beamforming mode may perform better in conditions of poor SINR. As another example, a typical digital beamforming mode may consume more UE resources (e.g., power resources and processor resources) than a typical hybrid/analog beamforming mode. Thus, a UE that is incapable of switching between a digital beamforming mode and a hybrid/analog beamforming mode may experience increased processor and power usage, suboptimal communication performance, and/or diminished throughput depending on the operating conditions of the UE.

Some techniques and apparatuses described herein provide triggering of a switch of a beamforming mode of a UE. For example, the switch may be triggered by the UE or by a base station associated with the UE. In some aspects, the switch may be based at least in part on a power condition of the UE, a channel condition of the UE, and/or the like. In some aspects, when operating in the digital beamforming mode, the UE may provide channel quality reporting for the digital beamforming mode (e.g., for digital beams of the digital beamforming mode) and for the hybrid/analog beamforming mode (e.g., for one or more hybrid/analog beams that may be used in the hybrid/analog beamforming mode). In some aspects, the UE may switch between different hybrid beamforming modes. Thus, a base station can rely on a relatively recent channel quality report for the hybrid/analog beamforming mode when configuring the UE to switch to the hybrid/analog beamforming mode, which improves communication performance of the UE and the base station. In some aspects, the techniques and apparatuses described herein may be particularly useful for millimeter wave communications, though the techniques and apparatuses described herein can be applied in frequency ranges other than millimeter wave.

Furthermore, some techniques and apparatuses described herein provide bandwidth part (BWP) based switching of beamforming modes. For example, a wireless communication device (e.g., a UE 120) may receive configuration information that indicates a mapping of bandwidth parts to beamforming modes of a set of beamforming modes supported by the wireless communication device. For example, the wireless communication device may be configured to use a beamforming mode (e.g., that uses a particular architecture and/or setting) for one or more communications based at least in part on a bandwidth part associated with the one or more communications.

In some aspects, the wireless communication device may be configured with a number of bandwidth parts (e.g., 4 bandwidth parts) for downlink communications. The base station may indicate a bandwidth part of the number of bandwidth parts for the wireless communication device to use to receive the downlink communications (e.g., an active bandwidth part). The wireless communication device may receive a mapping from the bandwidth part to a beamforming mode and may determine to receive the downlink communications using the beamforming mode that is mapped to the bandwidth part, without requiring additional signaling. In this way, the wireless communication device and the base station may conserve computing, communication, and/or network resources that may otherwise have been used to signal an indication of which beamforming mode to use to receive the downlink transmissions.

Still further, some techniques and apparatuses described herein provide dynamic indication and switching of beamforming modes. For example, a wireless communication device (e.g., a UE 120) may receive an indication of a beamforming mode, of a set of candidate beamforming modes supported by the wireless communication device, to use for transmitting a set of uplink communications or receiving a set of downlink communications. In some aspects, the indication may be based at least in part on a capability report that indicates that the wireless communication device supports the set of candidate beamforming modes, a request to use the beamforming mode, an SINR measured by the wireless communication device, a power state of the wireless communication device, a power setting of the wireless communication device, a heat state (e.g., temperature) of the wireless communication device, a heat setting of the wireless communication device, and/or the like.

The wireless communication device may transmit the set of uplink communications or receive the set of downlink communications based at least in part on the indication of the beamforming mode. In this way, the UE may conserve computing, communication, network, and/or power resources by providing flexibility to dynamically change a beamforming mode based at least in part on conditions that may make changing the beamforming mode more efficient than using a static beamforming mode.

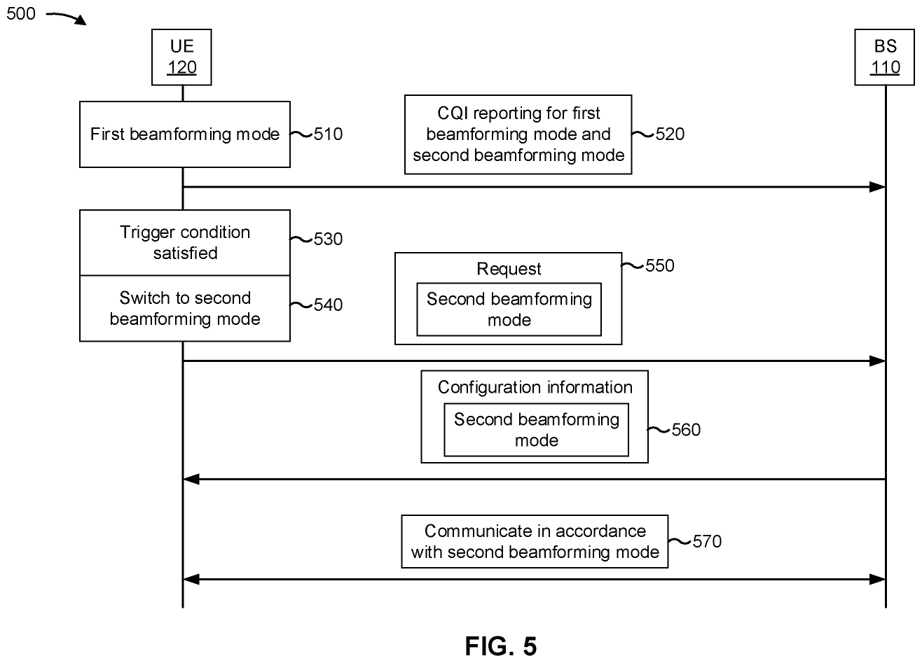

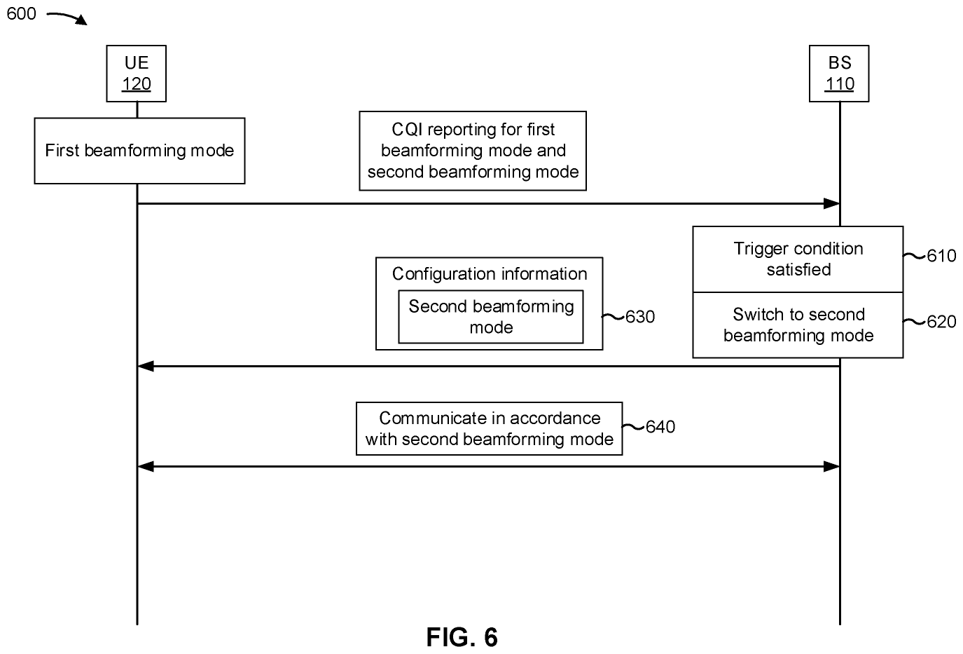

FIGS. 5 and 6 are diagrams illustrating examples 500 and 600 of switching beamforming modes based at least in part on a trigger condition, in accordance with the present disclosure. Example 500 shows an example of UE-triggered switching of beamforming modes, whereas example 600 shows an example of base station-triggered switching of beamforming modes. As shown, examples 500 and 600 include a UE 120 and a BS 110. The UE 120 of examples 500 and 600 may be capable of using a digital beamforming mode (e.g., based at least in part on a digital beamforming architecture 305/405) and an at least partially analog beamforming mode (e.g., based at least in part on a hybrid beamforming architecture 300/400 or an analog beamforming architecture with a single receive chain). For example, the UE 120 may be capable of switching between the digital beamforming mode and the at least partially analog beamforming mode. The at least partially analog beamforming mode may be referred to herein as a hybrid beamforming mode or a hybrid/analog beamforming mode. In some aspects, the base station 110 and the UE 120 may communicate using a frequency that satisfies a frequency threshold (e.g. a frequency that is within FR2, within FR4, above approximately 28 GHz, and/or the like).

As shown in FIG. 5, and by reference number 510, the UE 120 may operate in a first beamforming mode at the start of example 500. Similarly, example 600 may start with the UE 120 in the first beamforming mode. The first beamforming mode may be one of a digital beamforming mode or a hybrid/analog beamforming mode. For example, the techniques and apparatuses described herein describe switching between the first beamforming mode and a second beamforming mode, where the second beamforming mode is one of the digital beamforming mode or the hybrid/analog beamforming mode. In other words, techniques and apparatuses described herein provide for switching between a digital beamforming mode and a hybrid/analog beamforming mode in either direction (e.g., from digital to hybrid/analog or from hybrid/analog to digital). Additionally, techniques and apparatuses described herein provide for switching between two or more different hybrid/analog beamforming modes.

As shown by reference number 520, in some aspects, the UE 120 may provide channel quality indication (CQI) reporting for the first beamforming mode and for the second beamforming mode. For example, if the UE 120 is in a digital beamforming mode (e.g., if the first beamforming mode is the digital beamforming mode), then the UE 120 may be capable of determining CQI for one or more analog beams that may be used in the second beamforming mode. By providing CQI reports for one or more active beams of the first beamforming mode and for one or more analog beams of the second beamforming mode, the UE 120 may assist the BS 110 in selection of an analog beam if the UE 120 is to switch from the first beamforming mode to the second beamforming mode. For example, the BS 110 may have the benefit of more recent CQI reporting for the second beamforming mode, relative to if the UE 120 reports only CQI for an active beamforming mode of the UE 120 (e.g., only for the first beamforming mode or only for the second beamforming mode). In some aspects, the UE 120 may provide CQI reporting for the second beamforming mode less frequently than CQI reporting for the first beamforming mode. For example, the UE 120 may transmit the CQI reporting for the second beamforming mode using a lower duty cycle than a duty cycle used to transmit the CQI reporting for the first beamforming mode.

In some aspects, the UE 120 may receive configuration information from the BS 110. In some aspects, the configuration information may indicate that the UE is to determine a beamforming mode to use for transmitting and/or receiving communications based at least in part on an indication, from the base station, of a beamforming mode to use for transmitting and/or receiving the communications. In some aspects, the configuration information may indicate that the UE is to transmit a request to use a beamforming mode based at least in part on one or more conditions observed by the UE. A request transmitted by a UE may be referred to herein as a UE request. For example, the UE may be configured to request a beamforming mode based at least in part on an SINR measured by the UE, a power state of the UE, a power setting of the UE, a heat state of the UE, a heat setting of the UE, and/or the like.

In some aspects, the configuration information may indicate that the UE is to be configured with a default beamforming mode to use (e.g., in absence of an indication of a beamforming mode to use), a default beamforming mode to use based at least in part on a bandwidth part associated with communications for which the default beamforming mode is to be used, and/or the like. In some aspects, the configuration information may indicate that the UE is to use a beamforming mode, identified by the indication from the base station, beginning at a configured time from receiving the indication from the base station, for a configured period of time, for one or more channels, using one or more ranks (e.g., communication layers) associated with the beamforming mode, and/or the like.

In some aspects, the configuration information may indicate that the UE is to determine a beamforming mode to use for transmitting and/or receiving communications based at least in part on a bandwidth part associated with the communications. In some aspects, the configuration information may indicate a mapping of one or more bandwidth parts to a set of beamforming modes of the UE. In some aspects, the configuration information may indicate a mapping of a first set of bandwidth parts to a first beamforming mode of the UE, and may indicate a mapping of a second set of bandwidth parts to a second beamforming mode of the UE. For example, bandwidth parts A, B, C, and D may be mapped to beamforming mode 1, bandwidth parts E, F, G, and H may be mapped to beamforming mode 2, and/or the like.

In some aspects, the UE may support two or more beamforming modes, such as a digital beamforming mode, an analog beamforming mode, a hybrid beamforming mode, and/or the like. The configuration information may indicate that, based at least in part on receiving an indication to communicate using a particular bandwidth part, the UE is to use a beamforming mode that is mapped to the particular bandwidth part.

In some aspects, the UE may support different settings for beamforming modes. For example, the UE may support different inputs and/or outputs (e.g., a 2×2 or a 4×4 input/output mode), different analog to digital converter resolutions, and/or the like. The configuration information may indicate that, based at least in part on receiving an indication to communicate using a particular bandwidth part, the UE is to use a beamforming mode and/or a setting that is mapped to the particular bandwidth part.

In some aspects, the mapping may include mappings based at least in part on power consumption rates of the beamforming modes and frequency bandwidths (e.g., an amount of frequency spectrum) of the bandwidth parts. For example, a first beamforming mode may be mapped to a first bandwidth part having a first frequency bandwidth. A second beamforming mode may be mapped to a second bandwidth part having a second frequency bandwidth that is larger than the first frequency bandwidth. The first beamforming mode may be mapped to the first bandwidth based at least in part on the first beamforming mode having a higher power consumption rate than a power consumption rate of the second beamforming mode. In other words, the mapping may map beamforming modes having relatively high power consumption rates (e.g., digital beamforming) to bandwidth parts that are relatively narrow, and/or may map beamforming modes having relatively low power consumption rates (e.g., hybrid beamforming, analog beamforming, and/or the like) to bandwidth parts that are relatively wide.

In some aspects, the mapping may include mappings based at least in part on power consumption rates of the beamforming modes and frequencies of the bandwidth parts. For example, a first beamforming mode may be mapped to a first bandwidth part that is located at a first frequency. A second beamforming mode may be mapped to a second bandwidth part that is located at a second frequency that is higher than the first frequency. The first beamforming mode may be mapped to the first bandwidth based at least in part on the first beamforming mode having a higher power consumption rate than a power consumption rate of the second beamforming mode. In other words, the mapping may map beamforming modes having relatively high power consumption rates to bandwidth parts that are located at relatively low frequencies and may map beamforming modes having relatively low power consumption rates to bandwidth parts that are located at relatively high frequencies.

In some aspects, the UE 120 may transmit capability information to the BS 110. For example, the UE 120 may transmit an indication of a capability to communicate using one or more beamforming modes. For example, the UE 120 may transmit an indication of a capability to communicate using a digital beamforming mode, a hybrid beamforming mode, a digital beamforming mode, and/or the like. In some aspects, the UE may indicate support for different settings for beamforming modes. For example, the UE 120 may support different inputs and/or outputs (e.g., a 2×2 or a 4×4 input/output mode), different analog to digital converter resolutions, and/or the like. In some aspects, the UE 120 may transmit an indication that configuration of the UE 120 is complete. For example, the UE 120 may transmit an RRC complete message to the BS 110 to indicate that the UE 120 has been configured to communicate with the BS 110 and/or to indicate that the UE 120 has been configured with mapping information.

As shown by reference number 530, the UE 120 may determine that a trigger condition is satisfied. For example, the trigger condition may be associated with switching from the first beamforming mode to the second beamforming mode. In some aspects, the trigger condition may be associated with switching to a digital beamforming mode. For example, the trigger condition may indicate a channel condition threshold that, if satisfied, causes the UE 120 to switch to the digital beamforming mode (since the digital beamforming mode may be expected to provide better performance than the hybrid/analog beamforming mode in relatively good channel conditions). As another example, the trigger condition may indicate a battery power threshold that, if satisfied, causes the UE 120 to switch to the digital beamforming mode (since the digital beamforming mode may use more battery power than the hybrid/analog beamforming mode). In some aspects, the trigger condition may be associated with switching to a hybrid/analog beamforming mode. For example, the trigger condition may indicate a channel condition threshold that, if not satisfied, causes the UE 120 to switch to the hybrid/analog beamforming mode (since the hybrid/analog beamforming mode may be expected to provide better performance than the digital beamforming mode in relatively poor channel conditions). As another example, the trigger condition may indicate a battery power threshold that, if not satisfied (e.g., if the UE 120's battery power is lower than the threshold), causes the UE 120 to switch to the hybrid/analog beamforming mode.

In some aspects, the trigger condition may be binary, meaning that if the trigger condition is satisfied, then the UE 120 may use the first beamforming mode, and if the trigger condition is not satisfied, then the UE 120 may use the second beamforming mode. In some aspects, the UE 120 may be associated with a plurality of trigger conditions. For example, the UE 120 may be associated with a first trigger condition for switching from a first beamforming mode to a second beamforming mode, and may be associated with a second trigger condition, different than the first trigger condition, for switching from the second beamforming mode to the first beamforming mode. Additionally, or alternatively, the UE 120 may be associated with multiple different trigger conditions for switching from a first beamforming mode to a second beamforming mode, or from a second beamforming mode to a first beamforming mode.

In some aspects, the UE 120 may transmit a request to use a beamforming mode. In some aspects, the UE may transmit the request to use the beamforming mode via one or more of a MAC CE or a physical uplink control channel (PUCCH) communication. In some aspects, the request may indicate a time at which the UE requests to begin using the beamforming mode, a duration for which the UE requests to use the beamforming mode (e.g., a number of slots), an indication of a channel for which the UE requests to use the beamforming mode, a rank associated with the beamforming mode, and/or the like

In some aspects, the UE may determine to request the beamforming mode based at least in part on one or more conditions observed by the UE. For example, the UE may be configured to request a beamforming mode based at least in part on an SINR measured by the UE, a power state of the UE, a power setting of the UE, a heat state of the UE, a heat setting of the UE, and/or the like.

As shown by reference number 540, the UE 120 may determine to switch from the first beamforming mode to the second beamforming mode. For example, the UE 120 may determine to switch to the second beamforming mode based at least in part on the trigger condition described in connection with reference number 530 being satisfied. Accordingly, as shown by reference number 550, the UE 120 may transmit a request to the BS 110. As shown, the request may indicate the second beamforming mode. For example, the request may be a request for the BS 110 to cause the UE 120 to switch to the second beamforming mode.

As shown by reference number 560, the BS 110 may transmit, to the UE 120, configuration information based at least in part on receiving the request. The BS 110 may transmit the configuration information using downlink control information (DCI), medium access control (MAC) signaling, radio resource control (RRC) signaling, and/or the like. In some aspects, the configuration information may comprise RRC configuration information. In some aspects, the configuration information may comprise scheduling information, such as scheduling information associated with a communication (e.g., at reference number 570) to be performed by the UE 120. In other words, the configuration information can be semi-static or dynamic information.

As further shown, the configuration information may indicate that the UE 120 is to switch to the second beamforming mode. For example, the configuration information may indicate a beam configuration associated with the second beamforming mode. In some aspects, the configuration information may indicate one or more beams to be used by the UE 120, for example, based at least in part on transmission configuration indication (TCI) states associated with the one or more beams. In some aspects, the configuration information may be based at least in part on the CQI reporting described in connection with reference number 520.

In some aspects, the base station may transmit, and the UE may receive, an indication of a bandwidth part to use for one or more communications. In some aspects, the UE 120 may receive the indication via RRC signaling, one or more MAC CEs, or a DCI communication. In some aspects, the UE 120 may receive the indication as part of a resource grant (e.g., a dynamic resource grant, a configured resource grant, and/or the like). In some aspects, the UE 120 may receive an indication of a bandwidth part to use for transmitting and/or receiving the one or more communications. The UE 120 may configure a beamforming mode for the one or more communications based at least in part on the bandwidth part associated with the one or more communications (e.g., as indicated by the base station). In some aspects, the UE 120 may select, based at least in part on the indication of the bandwidth part to use, a beamforming mode, of a set of beamforming modes that the UE 120 supports, based at least in part on a mapping of the bandwidth part to the beamforming mode. For example, the UE 120 may select a digital beamforming mode, a hybrid beamforming mode, an analog beamforming mode, or the like. In some aspects, the set of beamforming modes that the UE 120 supports may be based at least in part on components of the UE (e.g., beamforming architecture).

In some aspects, the indication of the beamforming mode may indicate to use the beamforming mode instead of a default beamforming mode of a set of candidate beamforming modes supported by the UE. For example, the UE may be configured to use a default beamforming mode (e.g., a hybrid beamforming mode) in the absence of an indication to use a different beamforming mode (e.g., a digital beamforming mode). In some aspects, the default beamforming mode may be based at least in part on a bandwidth part associated with transmitting the set of uplink communications or receiving the set of downlink communications.

In some aspects, the indication of the beamforming mode may indicate a time at which the UE is to begin using the beamforming mode, a duration for which the UE is to use the beamforming mode, one or more channels (e.g., a data channel such as a physical downlink shared channel, a control channel such as a physical downlink control channel, and/or the like) for which the UE is to use the beamforming mode, an indication of a rank associated with the beamforming mode, and/or the like.

As shown by reference number 570, the UE 120 and the BS 110 may communicate in accordance with the second beamforming mode. For example, the UE 120 may use an architecture 300/400 or 305/405, corresponding to the activated beamforming mode, to receive a communication from the BS 110. Thus, the UE 120 may trigger a beamforming mode switch, for example, based at least in part on power conditions or channel conditions at the UE 120. UE-triggered beamforming mode switching may conserve resources of the BS 110 associated with determining whether the UE 120 should switch beamforming modes, and may conserve signaling resources associated with signaling a state of the UE 120 based at least in part on which the BS 110 can determine whether to switch the UE 120's beamforming mode.

As mentioned above, FIG. 6 shows an example 600 of BS-side triggering of a beamforming mode switch. As shown, the UE 120 may start example 600 in a first beamforming mode, and may optionally provide CQI reporting for the first beamforming mode and/or the second beamforming mode (e.g., if the first beamforming mode is a digital beamforming mode). As shown by reference number 610, the BS 110 may optionally determine that a trigger condition is satisfied with regard to the UE 120. The trigger condition may include any of the trigger conditions described with regard to example 500 of FIG. 5. For example, the BS 110 may determine that the trigger condition is satisfied based at least in part on the CQI reporting, based at least in part on other feedback from the UE 120, based at least in part on a sounding reference signal (SRS) or other uplink reference signal transmitted by the UE 120, and/or the like. Accordingly, as shown by reference number 620, the BS 110 may determine that the UE 120 is to switch to a second beamforming mode.

As shown by reference number 630, the BS 110 may transmit configuration information (e.g., configuration information shown by reference number 560) to cause the UE 120 to switch to the second beamforming mode. The configuration information may include RRC signaling, MAC signaling, DCI, or the like. In some aspects, the configuration information may indicate a bandwidth part that is mapped to a beamforming mode that the UE 120 is to use. The base station may determine a beamforming mode to use for one or more communications. For example, the base station 110 may select the beamforming mode based at least in part on receiving the request to use the beamforming mode, a desired throughput, a power state of the UE 120, an SINR of one or more signals received by the UE 120, an SINR of one or more signals received by the base station 110, an expected error rate for the one or more communications using the bandwidth part and the beamforming mode, a desired directionality of beams associated with the one or more communications, and/or the like.

In some aspects, the UE 120 may receive the indication via one or more MAC CEs, a DCI communication, and/or the like. In some aspects, the UE 120 may receive the indication as part of a resource grant (e.g., a dynamic resource grant, a configured resource grant, and/or the like). In some aspects, the indication of the beamforming mode may indicate to use the beamforming mode instead of a default beamforming mode of a set of candidate beamforming modes supported by the UE 120. For example, the UE 120 may be configured to use a default beamforming mode (e.g., a hybrid beamforming mode) in the absence of an indication to use a different beamforming mode (e.g., a digital beamforming mode). In some aspects, the default beamforming mode may be based at least in part on a bandwidth part associated with transmitting the set of uplink communications or receiving the set of downlink communications.

In some aspects, the indication of the beamforming mode may indicate a time at which the UE 120 is to begin using the beamforming mode, a duration for which the UE is to use the beamforming mode, one or more channels (e.g., a data channel such as a physical downlink shared channel, a control channel such as a physical downlink control channel, and/or the like) for which the UE 120 is to use the beamforming mode, an indication of a rank associated with the beamforming mode, and/or the like.

As shown by reference number 640, the BS 110 and the UE 120 may communicate based at least in part on the second beamforming mode. B S-triggered beamforming mode switching may conserve resources of the UE 120 associated with determining whether the UE 120 should switch beamforming modes and signaling the request from the UE 120 to switch to the second beamforming mode.

As indicated above, FIGS. 5 and 6 are provided as examples. Other examples may differ from what is described with regard to FIGS. 5 and 6.

FIG. 7 is a diagram illustrating an example process 700 performed, for example, by a UE, in accordance with the present disclosure. Example process 700 is an example where the UE (e.g., UE 120 and/or the like) performs operations associated with a triggering condition for switching between beamforming modes.

As shown in FIG. 7, in some aspects, process 700 may include receiving a request to switch from a first beamforming mode to a second beamforming mode, wherein one of the first beamforming mode and the second beamforming mode is a digital beamforming mode, and wherein the other of the first beamforming mode and the second beamforming mode is an at least partially analog beamforming mode (block 710). For example, the UE (e.g., using antenna 252, DEMOD 254, MIMO detector 256, receive processor 258, controller/processor 280, and/or the like) may receive a request to switch from a first beamforming mode to a second beamforming mode, as described above. In some aspects, one of the first beamforming mode and the second beamforming mode is a digital beamforming mode. In some aspects, the other of the first beamforming mode and the second beamforming mode is an analog beamforming mode or a hybrid beamforming mode. In some aspects, the UE may determine to switch from the first beamforming mode to the second beamforming mode.

As further shown in FIG. 7, in some aspects, process 700 may include performing a communication using the second beamforming mode (block 720). For example, the UE (e.g., using antenna 252, DEMOD 254, MIMO detector 256, receive processor 258, controller/processor 280, and/or the like) may perform a communication using the second beamforming mode, as described above.

Process 700 may include additional aspects, such as any single aspect or any combination of aspects described below and/or in connection with one or more other processes described elsewhere herein.

In a first aspect, determining to switch from the first beamforming mode to the second beamforming mode is based at least in part on receiving a request, from a base station, indicating to switch from the first beamforming mode to the second beamforming mode.

In a second aspect, alone or in combination with the first aspect, receiving the request is based at least in part on a channel condition associated with the UE.

In a third aspect, alone or in combination with one or more of the first and second aspects, receiving the request is based at least in part on a power condition associated with the UE.

In a fourth aspect, alone or in combination with one or more of the first through third aspects, process 700 includes transmitting, to a base station, a request indicating to switch from the first beamforming mode to the second beamforming mode; and receiving, based at least in part on the request, configuration information configuring the UE to switch from the first beamforming mode to the second beamforming mode.

In a fifth aspect, alone or in combination with one or more of the first through fourth aspects, the request is based at least in part on a channel condition associated with the UE.

In a sixth aspect, alone or in combination with one or more of the first through fifth aspects, the request is based at least in part on a power condition associated with the UE.

In a seventh aspect, alone or in combination with one or more of the first through sixth aspects, the first beamforming mode is the digital beamforming mode, and process 700 further comprises: transmitting a channel quality report associated with the second beamforming mode, performing the communication using the second beamforming mode is based at least in part on the channel quality report.

In an eighth aspect, alone or in combination with one or more of the first through seventh aspects, the channel quality report is associated with a longer periodicity than a periodicity associated with a channel quality report associated with the first beamforming mode.

In a ninth aspect, alone or in combination with one or more of the first through eighth aspects, an at least partially analog beamforming mode comprises an analog beamforming mode or a hybrid beamforming mode.

In a tenth aspect, alone or in combination with one or more of the first through ninth aspects, performing the communication using the second beamforming mode further comprises performing the communication using the second beamforming mode using a frequency that satisfies a frequency threshold.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a base station, in accordance with the present disclosure. Example process 800 is an example where the base station (e.g., base station 110 and/or the like) performs operations associated with a triggering condition for switching between beamforming modes.

As shown in FIG. 8, in some aspects, process 800 may include transmitting a request for a UE to switch from a first beamforming mode to a second beamforming mode, wherein one of the first beamforming mode and the second beamforming mode is a digital beamforming mode, and wherein the other of the first beamforming mode and the second beamforming mode is an analog beamforming mode or a hybrid beamforming mode (block 810). For example, the base station (e.g., using antenna 234, DEMOD 232, MIMO detector 236, receive processor 238, controller/processor 240, and/or the like) may determine that a UE is to switch from a first beamforming mode to a second beamforming mode, as described above. In some aspects, one of the first beamforming mode and the second beamforming mode is a digital beamforming mode. In some aspects, the other of the first beamforming mode and the second beamforming mode is an at least partially analog beamforming mode (that is, an analog beamforming mode or a hybrid beamforming mode).

As further shown in FIG. 8, in some aspects, process 800 may include transmitting, to the UE, configuration information configuring the UE to switch from the first beamforming mode to the second beamforming mode (block 820). For example, the base station (e.g., using controller/processor 240, transmit processor 220, TX MIMO processor 230, MOD 232, antenna 234, and/or the like) may transmit, to the UE and based at least in part on determining that the UE is to switch from the first beamforming mode to the second beamforming mode, configuration information configuring the UE to switch from the first beamforming mode to the second beamforming mode, as described above.

Process 800 may include additional aspects, such as any single aspect or any combination of aspects described below and/or in connection with one or more other processes described elsewhere herein.

In a first aspect, process 800 includes transmitting a request to the UE indicating to switch from the first beamforming mode to the second beamforming mode.

In a second aspect, alone or in combination with the first aspect, transmitting the request is based at least in part on a channel condition associated with the UE.

In a third aspect, alone or in combination with one or more of the first and second aspects, transmitting the request is based at least in part on a power condition associated with the UE.

In a fourth aspect, alone or in combination with one or more of the first through third aspects, process 800 includes receiving, from the UE, a request indicating to switch from the first beamforming mode to the second beamforming mode, wherein the configuration information is based at least in part on the request.

In a fifth aspect, alone or in combination with one or more of the first through fourth aspects, the request is based at least in part on a channel condition associated with the UE.

In a sixth aspect, alone or in combination with one or more of the first through fifth aspects, the request is based at least in part on a power condition associated with the UE.

In a seventh aspect, alone or in combination with one or more of the first through sixth aspects, the first beamforming mode is the digital beamforming mode, and the method further comprises: receiving a channel quality report associated with the second beamforming mode, and selecting a beam based at least in part on the channel quality report, the communication using the second beamforming mode is performed via the selected beam.

In an eighth aspect, alone or in combination with one or more of the first through seventh aspects, the channel quality report is associated with a longer periodicity than a periodicity associated with a channel quality report associated with the first beamforming mode.

In a ninth aspect, alone or in combination with one or more of the first through eighth aspects, the at least partially analog beamforming mode comprises an analog beamforming mode or a hybrid beamforming mode.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a UE, in accordance with the present disclosure. Example process 900 is an example where the UE (e.g., UE 120 and/or the like) performs operations associated with dynamic indications of beamforming modes for sets of communications.

As shown in FIG. 9, in some aspects, process 900 may include receiving an indication of a beamforming mode, of a set of candidate beamforming modes, to use for transmitting a set of uplink communications or receiving a set of downlink communications (block 910). For example, the UE (e.g., using receive processor 258, controller/processor 280, memory 282, and/or the like) may receive an indication of a beamforming mode, of a set of candidate beamforming modes, to use for transmitting a set of uplink communications or receiving a set of downlink communications, as described above.

As further shown in FIG. 9, in some aspects, process 900 may include transmitting the set of uplink communications or receiving the set of downlink communications based at least in part on the indication of the beamforming mode (block 920). For example, the UE (e.g., using transmit processor 264, controller/processor 280, memory 282, and/or the like) may transmit the set of uplink communications or receive the set of downlink communications based at least in part on the indication of the beamforming mode, as described above.

Process 900 may include additional aspects, such as any single aspect or any combination of aspects described below and/or in connection with one or more other processes described elsewhere herein.

In a first aspect, the set of candidate beamforming modes includes a hybrid beamforming mode, a digital beamforming mode, or an analog beamforming mode.

In a second aspect, alone or in combination with the first aspect, process 900 includes transmitting a request to use the beamforming mode, wherein receiving the indication of the beamforming mode is based at least in part on the request to use the beamforming mode.

In a third aspect, alone or in combination with one or more of the first and second aspects, transmitting the request to use the beamforming mode includes transmitting the request to use the beamforming mode via one or more of a MAC CE or a PUCCH communication.

In a fourth aspect, alone or in combination with one or more of the first through third aspects, receiving the indication of the beamforming mode includes receiving the indication of the beamforming mode via one or more of a MAC CE or DCI.

In a fifth aspect, alone or in combination with one or more of the first through fourth aspects, the indication of the beamforming mode includes an indication to use the beamforming mode instead of a default beamforming mode of the set of candidate beamforming modes.

In a sixth aspect, alone or in combination with one or more of the first through fifth aspects, the default beamforming mode is based at least in part on a bandwidth part associated with transmitting the set of uplink communications or receiving the set of downlink communications.

In a seventh aspect, alone or in combination with one or more of the first through sixth aspects, process 900 includes receiving an indication to cease use of the beamforming mode, and transmitting an additional set of uplink communications or receiving an additional set of downlink communications using the default beamforming mode based at least in part on the indication to cease use of the beamforming mode.

In an eighth aspect, alone or in combination with one or more of the first through seventh aspects, process 900 includes receiving one or more of: an indication of a time at which the UE is to begin using the beamforming mode, an indication of a duration for which the UE is to use the beamforming mode, an indication of a channel for which the UE is to use the beamforming mode, or an indication of a rank associated with the beamforming mode.

In a ninth aspect, alone or in combination with one or more of the first through eighth aspects, the beamforming mode is based at least in part on one or more of: a power state of the UE, an SINR of one or more signals received by the UE, or an SINR of one or more signals received by a base station.

In a tenth aspect, alone or in combination with one or more of the first through ninth aspects, transmitting the set of uplink communication or receiving the set of downlink communications includes transmitting the set of uplink communications or receiving the set of downlink communications using a frequency that satisfies a frequency threshold.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a base station, in accordance with the present disclosure. Example process 1000 is an example where the base station (e.g., base station 110 and/or the like) performs operations associated with dynamic indications of beamforming modes for sets of communications.

As shown in FIG. 10, in some aspects, process 1000 may include transmitting an indication of a beamforming mode, of a set of candidate beamforming modes, for a UE to use for transmitting a set of uplink communications or receiving a set of downlink communications (block 1010). For example, the base station (e.g., using transmit processor 220, controller/processor 240, memory 242, and/or the like) may transmit an indication of a beamforming mode, of a set of candidate beamforming modes, for a UE to use for transmitting a set of uplink communications or receiving a set of downlink communications, as described above.

As further shown in FIG. 10, in some aspects, process 1000 may include receiving the set of uplink communications or transmitting the set of downlink communications based at least in part on the indication of the beamforming mode (block 1020). For example, the base station (e.g., using receive processor 238, controller/processor 240, memory 242, and/or the like) may receive the set of uplink communications or transmit the set of downlink communications based at least in part on the indication of the beamforming mode, as described above.

Process 1000 may include additional aspects, such as any single aspect or any combination of aspects described below and/or in connection with one or more other processes described elsewhere herein.

In a first aspect, the set of candidate beamforming modes includes a hybrid beamforming mode, a digital beamforming mode, or an analog beamforming mode.

In a second aspect, alone or in combination with the first aspect, process 1000 includes receiving a request to use the beamforming mode, wherein transmitting the indication of the beamforming mode is based at least in part on the request to use the beamforming mode.

In a third aspect, alone or in combination with one or more of the first and second aspects, receiving the request to use the beamforming mode includes receiving the request to use the beamforming mode via one or more of a MAC CE or a PUCCH communication.

In a fourth aspect, alone or in combination with one or more of the first through third aspects, transmitting the indication of the beamforming mode includes transmitting the indication of the beamforming mode via one or more of a MAC CE or DCI.

In a fifth aspect, alone or in combination with one or more of the first through fourth aspects, the indication of the beamforming mode includes an indication for the UE to use the beamforming mode instead of a default beamforming mode of the set of candidate beamforming modes.

In a sixth aspect, alone or in combination with one or more of the first through fifth aspects, the default beamforming mode is based at least in part on a bandwidth part associated with the UE transmitting the set of uplink communications or receiving the set of downlink communications.

In a seventh aspect, alone or in combination with one or more of the first through sixth aspects, process 1000 includes transmitting an indication to cease use of the beamforming mode, and receiving an additional set of uplink communications or transmitting an additional set of downlink communications with the UE using the default beamforming mode based at least in part on the indication to cease use of the beamforming mode.

In an eighth aspect, alone or in combination with one or more of the first through seventh aspects, process 1000 includes transmitting one or more of: an indication of a time at which the UE is to begin using the beamforming mode, an indication of a duration for which the UE is to use the beamforming mode, an indication of a channel for which the UE is to use the beamforming mode, or an indication of a rank associated with the beamforming mode.

In a ninth aspect, alone or in combination with one or more of the first through eighth aspects, process 1000 includes selecting the beamforming mode based at least in part on one or more of: an indicated power state of the UE, an indicated SINR of one or more signals received by the UE, or an SINR of one or more signals received by the base station.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a UE, in accordance with the present disclosure. Example process 1100 is an example where the UE (e.g., UE 120 and/or the like) performs operations associated with mapping of beamforming modes to bandwidth parts.

As shown in FIG. 11, in some aspects, process 1100 may include receiving configuration information that indicates a mapping of one or more bandwidth parts to a set of beamforming modes of the UE (block 1110). For example, the UE (e.g., using receive processor 258, controller/processor 280, memory 282, and/or the like) may receive configuration information that indicates a mapping of one or more bandwidth parts to a set of beamforming modes of the UE, as described above.

As further shown in FIG. 11, in some aspects, process 1100 may include receiving, via a bandwidth part of the one or more bandwidth parts, a downlink communication using a beamforming mode, of the set of beamforming modes of the UE, that is mapped to the bandwidth part based at least in part on the configuration information (block 1120). For example, the UE (e.g., using receive processor 258, controller/processor 280, memory 282, and/or the like) may receive, via a bandwidth part of the one or more bandwidth parts, a downlink communication using a beamforming mode, of the set of beamforming modes of the UE, that is mapped to the bandwidth part based at least in part on the configuration information, as described above.

Process 1100 may include additional aspects, such as any single aspect or any combination of aspects described below and/or in connection with one or more other processes described elsewhere herein.

In a first aspect, the configuration information indicates a mapping of a first set of bandwidth parts to a first beamforming mode of the set of beamforming modes of the UE, and the configuration information indicates a mapping of a second set of bandwidth parts to a second beamforming mode of the set of beamforming modes of the UE.

In a second aspect, alone or in combination with the first aspect, the set of beamforming modes of the UE includes one or more of: a digital beamforming mode, an analog beamforming mode, or a hybrid beamforming mode.

In a third aspect, alone or in combination with one or more of the first and second aspects, the configuration information indicates a mapping of the one or more bandwidth parts to a digital beamforming mode of the UE that defines a number of inputs and a number of outputs.

In a fourth aspect, alone or in combination with one or more of the first through third aspects, receiving the configuration information that indicates the mapping of the one or more bandwidth parts to the set of beamforming modes of the UE includes receiving the configuration information that indicates the mapping of the one or more bandwidth parts to the set of beamforming modes of the UE via one or more of: RRC signaling, one or more MAC CEs, or a DCI communication.

In a fifth aspect, alone or in combination with one or more of the first through fourth aspects, process 1100 includes receiving an indication to use the bandwidth part to receive the downlink communication via one or more of: RRC signaling, one or more MAC CEs, or a DCI communication.

In a sixth aspect, alone or in combination with one or more of the first through fifth aspects, the mapping of the one or more bandwidth parts to the set of beamforming modes of the UE includes a first mapping of a first beamforming mode to a first bandwidth part, where the first beamforming mode is associated with a first power consumption rate, and the first bandwidth has a first frequency bandwidth; and a second mapping of a second beamforming mode to a second bandwidth part, where the second beamforming mode is associated with a second power consumption rate that is lower than the first power consumption rate, and the second bandwidth has a second frequency bandwidth that is larger than the first frequency bandwidth.

In a seventh aspect, alone or in combination with one or more of the first through sixth aspects, the mapping of the one or more bandwidth parts to the set of beamforming modes of the UE includes a first mapping of a first beamforming mode to a first bandwidth part, where the first beamforming mode is associated with a first power consumption rate, and the first bandwidth has a first frequency, and a second mapping of a second beamforming mode to a second bandwidth part, where the second beamforming mode is associated with a second power consumption rate that is lower than the first power consumption rate, and the second bandwidth has a second frequency that is higher than the first frequency.

In an eighth aspect, alone or in combination with one or more of the first through ninth aspects, the bandwidth part is associated with a frequency that satisfies a frequency threshold.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a base station, in accordance with the present disclosure. Example process 1200 is an example where the base station (e.g., base station 110 and/or the like) performs operations associated with mapping of beamforming modes to bandwidth parts.

As shown in FIG. 12, in some aspects, process 1200 may include transmitting configuration information that indicates a mapping of one or more bandwidth parts to a set of beamforming modes of a UE (block 1210). For example, the base station (e.g., using transmit processor 220, controller/processor 240, memory 242, and/or the like) may transmit configuration information that indicates a mapping of one or more bandwidth parts to a set of beamforming modes of a UE, as described above.

As further shown in FIG. 12, in some aspects, process 1200 may include transmitting, via a bandwidth part of the one or more bandwidth parts, a downlink communication based at least in part on the UE using a beamforming mode, of the set of beamforming modes of the UE, that is mapped to the bandwidth part based at least in part on the configuration information (block 1220). For example, the base station (e.g., using transmit processor 220, controller/processor 240, memory 242, and/or the like) may transmit, via a bandwidth part of the one or more bandwidth parts, a downlink communication based at least in part on the UE using a beamforming mode, of the set of beamforming modes of the UE, that is mapped to the bandwidth part based at least in part on the configuration information, as described above.

Process 1200 may include additional aspects, such as any single aspect or any combination of aspects described below and/or in connection with one or more other processes described elsewhere herein.

In a first aspect, the configuration information indicates a mapping of a first set of bandwidth parts to a first beamforming mode of the set of beamforming modes of the UE, and the configuration information indicates a mapping of a second set of bandwidth parts to a second beamforming mode of the set of beamforming modes of the UE.

In a second aspect, alone or in combination with the first aspect, the set of beamforming modes of the UE includes one or more of: a digital beamforming mode, an analog beamforming mode, or a hybrid beamforming mode.

In a third aspect, alone or in combination with one or more of the first and second aspects, the configuration information indicates a mapping of the one or more bandwidth parts to a digital beamforming mode of the UE that defines a number of inputs and a number of outputs.

In a fourth aspect, alone or in combination with one or more of the first through third aspects, transmitting the configuration information that indicates the mapping of the one or more bandwidth parts to the set of beamforming modes of the UE includes transmitting the configuration information that indicates the mapping of the one or more bandwidth parts to the set of beamforming modes of the UE via one or more of: RRC signaling, one or more MAC CEs, or a DCI communication.

In a fifth aspect, alone or in combination with one or more of the first through fourth aspects, process 1200 includes transmitting an indication to use the bandwidth part to receive the downlink communication via one or more of: RRC signaling, one or more MAC CEs, or a DCI communication.

In a sixth aspect, alone or in combination with one or more of the first through fifth aspects, the mapping of the one or more bandwidth parts to the set of beamforming modes of the UE includes a first mapping of a first beamforming mode to a first bandwidth part, where the first beamforming mode is associated with a first power consumption rate, and the first bandwidth has a first frequency bandwidth, and a second mapping of a second beamforming mode to a second bandwidth part, where the second beamforming mode is associated with a second power consumption rate that is lower than the first power consumption rate, and the second bandwidth has a second frequency bandwidth that is larger than the first frequency bandwidth.

In a seventh aspect, alone or in combination with one or more of the first through sixth aspects, the mapping of the one or more bandwidth parts to the set of beamforming modes of the UE includes a first mapping of a first beamforming mode to a first bandwidth part, where the first beamforming mode is associated with a first power consumption rate, and the first bandwidth has a first frequency, and a second mapping of a second beamforming mode to a second bandwidth part, where the second beamforming mode is associated with a second power consumption rate that is lower than the first power consumption rate, and the second bandwidth has a second frequency that is higher than the first frequency.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

The following provides an overview of some Aspects of the present disclosure:

Aspect 1: A method of wireless communication performed by a user equipment (UE), comprising: determining to switch from a first beamforming mode to a second beamforming mode, wherein one of the first beamforming mode and the second beamforming mode is a digital beamforming mode, and wherein the other of the first beamforming mode and the second beamforming mode is an at least partially analog beamforming mode; and performing a communication using the second beamforming mode.

Aspect 2: The method of Aspect 1, wherein determining to switch from the first beamforming mode to the second beamforming mode is based at least in part on receiving a request, from a base station, indicating to switch from the first beamforming mode to the second beamforming mode.

Aspect 3: The method of Aspect 2, wherein receiving the request is based at least in part on a channel condition associated with the UE.

Aspect 4: The method of Aspect 2, wherein receiving the request is based at least in part on a power condition associated with the UE.

Aspect 5: The method of any of Aspects 1-4, further comprising: transmitting, to a base station, a request indicating to switch from the first beamforming mode to the second beamforming mode; and receiving, based at least in part on the request, configuration information configuring the UE to switch from the first beamforming mode to the second beamforming mode.

Aspect 6: The method of Aspect 5, wherein the request is based at least in part on a channel condition associated with the UE.

Aspect 7: The method of Aspect 5, wherein the request is based at least in part on a power condition associated with the UE.

Aspect 8: The method of any of Aspects 1-7, wherein the first beamforming mode is the digital beamforming mode, and wherein the method further comprises: transmitting a channel quality report associated with the second beamforming mode, wherein performing the communication using the second beamforming mode is based at least in part on the channel quality report.

Aspect 9: The method of Aspect 8, wherein the channel quality report is associated with a longer periodicity than a periodicity associated with a channel quality report associated with the first beamforming mode.

Aspect 10: The method of any of Aspects 1-9, wherein the at least partially analog beamforming mode comprises an analog beamforming mode or a hybrid beamforming mode.

Aspect 11: The method of any of Aspects 1-10, wherein performing the communication using the second beamforming mode further comprises: performing the communication using the second beamforming mode using a frequency that satisfies a frequency threshold.

Aspect 12: The method of any of Aspects 1-11, further comprising: receiving configuration information that indicates a mapping of one or more bandwidth parts to a set of beamforming modes of the UE, the set of beamforming modes including the first beamforming mode and the second beamforming mode; and switching to a bandwidth part to which the second beamforming mode is mapped based at least in part on the configuration information.

Aspect 13: The method of Aspect 12, wherein the configuration information indicates a mapping of a first set of bandwidth parts to the first beamforming mode of the set of beamforming modes of the UE, and wherein the configuration information indicates a mapping of a second set of bandwidth parts to the second beamforming mode of the set of beamforming modes of the UE.

Aspect 14: The method of Aspect 12, wherein the configuration information indicates a mapping of the one or more bandwidth parts to the digital beamforming mode of the UE, wherein the digital beamforming mode defines a number of inputs and a number of outputs.

Aspect 15: The method of Aspect 12, wherein receiving the configuration information comprises: receiving the configuration information via at least: radio resource control signaling, one or more medium access control elements, a downlink control information communication, or a combination thereof.

Aspect 16: The method of Aspect 12, further comprising: receiving an indication to use the bandwidth part to perform the communication via at least: radio resource control signaling, one or more medium access control elements, a downlink control information communication, or a combination thereof.

Aspect 17: The method of Aspect 12, wherein the mapping of the one or more bandwidth parts to the set of beamforming modes of the UE comprises: a first mapping of the first beamforming mode to a first bandwidth part, wherein the first beamforming mode is associated with a first power consumption rate, and wherein the first bandwidth part has a first frequency bandwidth; and a second mapping of the second beamforming mode to a second bandwidth part, wherein the second beamforming mode is associated with a second power consumption rate that is lower than the first power consumption rate, and wherein the second bandwidth part has a second frequency bandwidth that is larger than the first frequency bandwidth.

Aspect 18: The method of Aspect 12, wherein the mapping of the one or more bandwidth parts to the set of beamforming modes of the UE comprises: a first mapping of the first beamforming mode to the a bandwidth part, wherein the first beamforming mode is associated with a first power consumption rate, and wherein the first bandwidth part has a first frequency; and a second mapping of the second beamforming mode to a second bandwidth part, wherein the second beamforming mode is associated with a second power consumption rate that is lower than the first power consumption rate, and wherein the second bandwidth part has a second frequency that is higher than the first frequency.

Aspect 19: The method of any of Aspects 1-18, further comprising: receiving an indication of the second beamforming mode, of a set of candidate beamforming modes including the first beamforming mode and the second beamforming mode, to use for performing the communication.

Aspect 20: The method of Aspect 19, further comprising: transmitting a request to use the second beamforming mode, wherein receiving the indication of the second beamforming mode is based at least in part on the request to use the second beamforming mode.

Aspect 21: The method of Aspect 20, wherein transmitting the request to use the beamforming mode comprises: transmitting the request to use the beamforming mode via one or more of a medium access control element or a physical uplink control channel communication.

Aspect 22: The method of Aspect 19, wherein receiving the indication of the second beamforming mode comprises: receiving the indication of the second beamforming mode via one or more of a medium access control element or downlink control information.

Aspect 23: The method of Aspect 19, wherein the indication of the second beamforming mode includes an indication to use the second beamforming mode instead of a default beamforming mode of the set of candidate beamforming modes.

Aspect 24: The method of Aspect 23, wherein the default beamforming mode is based at least in part on a bandwidth part associated with performing the communication.

Aspect 25: The method of Aspect 23, further comprising: receiving an indication to cease use of the second beamforming mode; and performing an additional communication using the default beamforming mode based at least in part on the indication to cease use of the second beamforming mode.

Aspect 26: The method of Aspect 19, further comprising: receiving at least: an indication of a time at which the UE is to begin using the second beamforming mode, an indication of a duration for which the UE is to use the second beamforming mode, an indication of a channel for which the UE is to use the second beamforming mode, an indication of a rank associated with the second beamforming mode, or a combination thereof.

Aspect 27: The method of any of Aspects 1-26, wherein the second beamforming mode is based at least in part on one or more of: a power state of the UE, a signal to interference plus noise ratio of one or more signals received by the UE, or a signal to interference plus noise ratio of one or more signals received by a base station.

Aspect 28: A method of wireless communication performed by a base station, comprising: determining that a user equipment (UE) is to switch from a first beamforming mode to a second beamforming mode, wherein one of the first beamforming mode and the second beamforming mode is a digital beamforming mode, and wherein the other of the first beamforming mode and the second beamforming mode is an at least partially analog beamforming mode; and transmitting, to the UE and based at least in part on determining that the UE is to switch from the first beamforming mode to the second beamforming mode, configuration information configuring the UE to switch from the first beamforming mode to the second beamforming mode.

Aspect 29: The method of Aspect 28, further comprising: transmitting a request to the UE indicating to switch from the first beamforming mode to the second beamforming mode.

Aspect 30: The method of Aspect 29, wherein transmitting the request is based at least in part on a channel condition associated with the UE.

Aspect 31: The method of Aspect 29, wherein transmitting the request is based at least in part on a power condition associated with the UE.

Aspect 32: The method of any of Aspects 28-31, further comprising: receiving, from the UE, a request indicating to switch from the first beamforming mode to the second beamforming mode, wherein the configuration information is based at least in part on the request.

Aspect 33: The method of Aspect 32, wherein the request is based at least in part on a channel condition associated with the UE.

Aspect 34: The method of Aspect 32, wherein the request is based at least in part on a power condition associated with the UE.

Aspect 35: The method of Aspect 32, wherein the first beamforming mode is the digital beamforming mode, and wherein the method further comprises: receiving a channel quality report associated with the second beamforming mode; and selecting a beam based at least in part on the channel quality report, wherein the communication using the second beamforming mode is performed via the selected beam.

Aspect 36: The method of Aspect 35, wherein the channel quality report is associated with a longer periodicity than a periodicity associated with a channel quality report associated with the first beamforming mode.

Aspect 37: The method of any of Aspects 28-36, wherein the at least partially analog beamforming mode comprises an analog beamforming mode or a hybrid beamforming mode.

Aspect 38: The method of Aspect 37, further comprising: transmitting configuration information that indicates a mapping of one or more bandwidth parts to a set of beamforming modes of the UE, the set of beamforming modes including the first beamforming mode and the second beamforming mode; and communicating with the UE on a bandwidth part to which the second beamforming mode is mapped.

Aspect 39: The method of Aspect 38, wherein the configuration information indicates a mapping of a first set of bandwidth parts to the first beamforming mode of the set of beamforming modes of the UE, and wherein the configuration information indicates a mapping of a second set of bandwidth parts to the second beamforming mode of the set of beamforming modes of the UE.

Aspect 40: The method of Aspect 39, wherein the configuration information indicates a mapping of the one or more bandwidth parts to the digital beamforming mode of the UE, wherein the digital beamforming mode defines a number of inputs and a number of outputs.

Aspect 41: The method of Aspect 39, wherein transmitting the configuration information comprises: transmitting the configuration information via at least: radio resource control signaling, one or more medium access control elements, a downlink control information communication, or a combination thereof.

Aspect 42: The method of Aspect 39, further comprising: transmitting the configuration information to use the bandwidth part to perform a communication via at least: radio resource control signaling, one or more medium access control elements, a downlink control information communication, or a combination thereof.

Aspect 43: The method of Aspect 39, wherein the mapping of the one or more bandwidth parts to the set of beamforming modes of the UE comprises: a first mapping of the first beamforming mode to a first bandwidth part, wherein the first beamforming mode is associated with a first power consumption rate, and wherein the first bandwidth part has a first frequency bandwidth; and a second mapping of the second beamforming mode to a second bandwidth part, wherein the second beamforming mode is associated with a second power consumption rate that is lower than the first power consumption rate, and wherein the second bandwidth part has a second frequency bandwidth that is larger than the first frequency bandwidth.

Aspect 44: The method of Aspect 39, wherein the mapping of the one or more bandwidth parts to the set of beamforming modes of the UE comprises: a first mapping of the first beamforming mode to a first bandwidth part, wherein the first beamforming mode is associated with a first power consumption rate, and wherein the first bandwidth part has a first frequency; and a second mapping of the second beamforming mode to a second bandwidth part, wherein the second beamforming mode is associated with a second power consumption rate that is lower than the first power consumption rate, and wherein the second bandwidth part has a second frequency that is higher than the first frequency.

Aspect 45: The method of any of Aspects 29-44, further comprising: receiving a request to use the second beamforming mode, wherein the configuration information is based at least in part on the request to use the second beamforming mode.

Aspect 46: The method of Aspect 45, wherein receiving the request to use the beamforming mode comprises: receiving the request to use the beamforming mode via one or more of a medium access control element or a physical uplink control channel communication.

Aspect 47: The method of Aspect 45, wherein transmitting the indication of the second beamforming mode comprises: transmitting the indication of the second beamforming mode via one or more of a medium access control element or downlink control information.

Aspect 48: The method of Aspect 45, wherein the configuration information includes an indication to use the second beamforming mode instead of a default beamforming mode.

Aspect 49: The method of Aspect 48, wherein the default beamforming mode is based at least in part on a bandwidth part associated with performing the communication.

Aspect 50: The method of Aspect 49, further comprising: transmitting an indication to cease use of the second beamforming mode; and performing an additional communication using the default beamforming mode.

Aspect 51: The method of Aspect 45, further comprising: receiving at least: an indication of a time at which the UE is to begin using the second beamforming mode, an indication of a duration for which the UE is to use the second beamforming mode, an indication of a channel for which the UE is to use the second beamforming mode, an indication of a rank associated with the second beamforming mode, or a combination thereof.

Aspect 52: The method of any of Aspects 28-51, wherein the second beamforming mode is based at least in part on one or more of: a power state of the UE, a signal to interference plus noise ratio of one or more signals received by the UE, or a signal to interference plus noise ratio of one or more signals received by a base station.

Aspect 53: A method of wireless communication performed by a user equipment (UE), comprising: receiving a request to switch from a first beamforming mode to a second beamforming mode, wherein one of the first beamforming mode and the second beamforming mode is a digital beamforming mode, and wherein the other of the first beamforming mode and the second beamforming mode is a hybrid beamforming mode or an analog beamforming mode; and performing a communication using the second beamforming mode.

Aspect 54: The method of Aspect 53, wherein the request is received from a base station.

Aspect 55: The method of Aspect 54, wherein receiving the request is based at least in part on a channel condition associated with the UE.

Aspect 56: The method of Aspect 54, wherein receiving the request is based at least in part on a power condition associated with the UE.

Aspect 57: The method of any of Aspects 53-56, further comprising: transmitting, to a base station, a UE request indicating to switch from the first beamforming mode to the second beamforming mode; and receiving, based at least in part on the UE request, configuration information including the request to switch from the first beamforming mode to the second beamforming mode.

Aspect 58: The method of Aspect 57, wherein the UE request is based at least in part on a channel condition associated with the UE or a power condition associated with the UE.

Aspect 59: The method of any of Aspects 53-58, wherein the first beamforming mode is the digital beamforming mode, and further comprising: transmitting a channel quality report associated with the second beamforming mode, wherein performing the communication using the second beamforming mode is based at least in part on the channel quality report.

Aspect 60: The method of any of Aspects 53-59, comprising: performing the communication using the second beamforming mode using a frequency that satisfies a frequency threshold.

Aspect 61: The method of any of Aspects 53-60, further comprising: receiving configuration information that indicates a mapping of one or more bandwidth parts to a set of beamforming modes of the UE, the set of beamforming modes including the first beamforming mode and the second beamforming mode; and switching to a bandwidth part to which the second beamforming mode is mapped based at least in part on the configuration information.

Aspect 62: The method of Aspect 61, wherein the configuration information indicates a mapping of a first set of bandwidth parts to the first beamforming mode of the set of beamforming modes of the UE, and wherein the configuration information indicates a mapping of a second set of bandwidth parts to the second beamforming mode of the set of beamforming modes of the UE.

Aspect 63: The method of Aspect 61, wherein the configuration information indicates a mapping of the one or more bandwidth parts to the digital beamforming mode of the UE, wherein the digital beamforming mode defines a number of inputs and a number of outputs.

Aspect 64: The method of any of Aspects 53-63, wherein the request includes an indication of the second beamforming mode, of a set of candidate beamforming modes including the first beamforming mode and the second beamforming mode, to use for performing the communication.

Aspect 65: The method of Aspect 64, further comprising: transmitting a UE request to use the second beamforming mode, wherein receiving the indication of the second beamforming mode is based at least in part on the UE request to use the second beamforming mode.

Aspect 66: The method of Aspect 64, comprising: receiving the indication of the second beamforming mode via one or more of a medium access control element or downlink control information.

Aspect 67: The method of any of Aspects 53-66, wherein the second beamforming mode is based at least in part on one or more of: a power state of the UE, a signal to interference plus noise ratio of one or more signals received by the UE, or a signal to interference plus noise ratio of one or more signals received by a base station.

Aspect 68: A method of wireless communication performed by a base station, comprising: transmitting a request to a user equipment (UE) indicating to switch from a first beamforming mode to a second beamforming mode, wherein one of the first beamforming mode and the second beamforming mode is a digital beamforming mode, and wherein the other of the first beamforming mode and the second beamforming mode is an analog beamforming mode or a hybrid beamforming mode; and transmitting, to the UE, configuration information configuring the UE to switch from the first beamforming mode to the second beamforming mode.

Aspect 69: The method of Aspect 68, wherein transmitting the request is based at least in part on a channel condition associated with the UE.

Aspect 70: The method of any of Aspects 68-69, wherein transmitting the request is based at least in part on a power condition associated with the UE.

Aspect 71: The method of any of Aspects 68-70, further comprising: receiving, from the UE, a UE request indicating to switch from the first beamforming mode to the second beamforming mode, wherein the configuration information is based at least in part on the UE request.

Aspect 72: The method of any of Aspects 68-71, wherein the at least partially analog beamforming mode comprises an analog beamforming mode or a hybrid beamforming mode.

Aspect 73: The method of any of Aspects 68-72, further comprising: transmitting configuration information that indicates a mapping of one or more bandwidth parts to a set of beamforming modes of the UE, the set of beamforming modes including the first beamforming mode and the second beamforming mode; and communicating with the UE on a bandwidth part to which the second beamforming mode is mapped.

Aspect 74: The method of any of Aspects 68-73, wherein the configuration information indicates a mapping of a first set of bandwidth parts to the first beamforming mode of the set of beamforming modes of the UE, and wherein the configuration information indicates a mapping of a second set of bandwidth parts to the second beamforming mode of the set of beamforming modes of the UE.

Aspect 75: The method of any of Aspects 68-74, wherein the configuration information indicates a mapping of the one or more bandwidth parts to the digital beamforming mode of the UE, wherein the digital beamforming mode defines a number of inputs and a number of outputs.

Aspect 76: The method of Aspect 75, wherein the mapping of the one or more bandwidth parts to the set of beamforming modes of the UE comprises: a first mapping of the first beamforming mode to a first bandwidth part, wherein the first beamforming mode is associated with a first power consumption rate, and wherein the first bandwidth part has a first frequency bandwidth; and a second mapping of the second beamforming mode to a second bandwidth part, wherein the second beamforming mode is associated with a second power consumption rate that is lower than the first power consumption rate, and wherein the second bandwidth part has a second frequency bandwidth that is larger than the first frequency bandwidth.

Aspect 78: The method of Aspect 75, wherein the mapping of the one or more bandwidth parts to the set of beamforming modes of the UE comprises: a first mapping of the first beamforming mode to a first bandwidth part, wherein the first beamforming mode is associated with a first power consumption rate, and wherein the first bandwidth part has a first frequency; and a second mapping of the second beamforming mode to a second bandwidth part, wherein the second beamforming mode is associated with a second power consumption rate that is lower than the first power consumption rate, and wherein the second bandwidth part has a second frequency that is higher than the first frequency.

Aspect 79: The method of any of Aspects 68-78, further comprising: receiving a UE request to use the second beamforming mode, wherein the configuration information is based at least in part on the UE request to use the second beamforming mode.

Aspect 80: The method of any of Aspects 68-79, wherein the second beamforming mode is based at least in part on one or more of: a power state of the UE, a signal to interference plus noise ratio of one or more signals received by the UE, or a signal to interference plus noise ratio of one or more signals received by a base station.

Aspect 81: An apparatus for wireless communication at a device, comprising a processor; memory coupled with the processor; and instructions stored in the memory and executable by the processor to cause the apparatus to perform the method of one or more of Aspects 1-80.

Aspect 82: A device for wireless communication, comprising a memory and one or more processors coupled to the memory, the one or more processors configured to perform the method of one or more of Aspects 1-80.

Aspect 83: An apparatus for wireless communication, comprising at least one means for performing the method of one or more of Aspects 1-80.

Aspect 84: A non-transitory computer-readable medium storing code for wireless communication, the code comprising instructions executable by a processor to perform the method of one or more of Aspects 1-80.

Aspect 85: A non-transitory computer-readable medium storing a set of instructions for wireless communication, the set of instructions comprising one or more instructions that, when executed by one or more processors of a device, cause the device to perform the method of one or more of Aspects 1-80.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive a request to switch from a first beamforming mode to a second beamforming mode, wherein one of the first beamforming mode and the second beamforming mode is a digital beamforming mode, and wherein the other of the first beamforming mode and the second beamforming mode is a hybrid beamforming mode or an analog beamforming mode; and
perform a communication using the second beamforming mode.

2. The apparatus of claim 1, wherein the request is received from a base station.

3. The apparatus of claim 2, wherein receiving the request is based at least in part on a channel condition associated with the UE.

4. The apparatus of claim 2, wherein receiving the request is based at least in part on a power condition associated with the UE.

5. The apparatus of claim 1, wherein the one or more processors are further configured to:
transmit, to a base station, a UE request indicating to switch from the first beamforming mode to the second beamforming mode; and
receive, based at least in part on the UE request, configuration information including the request to switch from the first beamforming mode to the second beamforming mode.

6. The apparatus of claim 5, wherein the UE request is based at least in part on a channel condition associated with the UE or a power condition associated with the UE.

7. The apparatus of claim 1, wherein the first beamforming mode is the digital beamforming mode, and
wherein the one or more processors are further configured to:
transmit a channel quality report associated with the second beamforming mode, wherein performing the communication using the second beamforming mode is based at least in part on the channel quality report.

8. The apparatus of claim 1, wherein the one or more processors, to perform the communication using the second beamforming mode, are configured to:
perform the communication using the second beamforming mode using a frequency that satisfies a frequency threshold.

9. The apparatus of claim 1, wherein the one or more processors are further configured to:
receive configuration information that indicates a mapping of one or more bandwidth parts to a set of beamforming modes of the UE, the set of beamforming modes including the first beamforming mode and the second beamforming mode; and
switch to a bandwidth part to which the second beamforming mode is mapped based at least in part on the configuration information.

10. The apparatus of claim 9, wherein the configuration information indicates a mapping of a first set of bandwidth parts to the first beamforming mode of the set of beamforming modes of the UE, and
wherein the configuration information indicates a mapping of a second set of bandwidth parts to the second beamforming mode of the set of beamforming modes of the UE.

11. The apparatus of claim 9, wherein the configuration information indicates a mapping of the one or more bandwidth parts to the digital beamforming mode of the UE, wherein the digital beamforming mode defines a number of inputs and a number of outputs.

12. The apparatus of claim 1, wherein the request includes an indication of the second beamforming mode, of a set of candidate beamforming modes including the first beamforming mode and the second beamforming mode, to use for performing the communication.

13. The apparatus of claim 12, wherein the one or more processors are further configured to:
transmit a UE request to use the second beamforming mode,
wherein receiving the indication of the second beamforming mode is based at least in part on the UE request to use the second beamforming mode.

14. The apparatus of claim 12, wherein the one or more processors, to receive the indication of the second beamforming mode, are configured to:
receive the indication of the second beamforming mode via one or more of a medium access control element or downlink control information.

15. The apparatus of claim 1, wherein the second beamforming mode is based at least in part on one or more of:
a power state of the UE,
a signal to interference plus noise ratio of one or more signals received by the UE, or
a signal to interference plus noise ratio of one or more signals received by a base station.

16. An apparatus for wireless communication at a base station, comprising:
a memory; and
one or more processors, coupled to the memory, configured to:
transmit a request to a user equipment (UE) indicating to switch from a first beamforming mode to a second beamforming mode, wherein one of the first beamforming mode and the second beamforming mode is a digital beamforming mode, and wherein the other of the first beamforming mode and the second beamforming mode is an analog beamforming mode or a hybrid beamforming mode; and
transmit, to the UE, configuration information configuring the UE to switch from the first beamforming mode to the second beamforming mode.

17. The apparatus of claim 16, wherein transmitting the request is based at least in part on a channel condition associated with the UE.

18. The apparatus of claim 16, wherein transmitting the request is based at least in part on a power condition associated with the UE.

19. The apparatus of claim 16, wherein the one or more processors are further configured to:
receive, from the UE, a UE request indicating to switch from the first beamforming mode to the second beamforming mode, wherein the configuration information is based at least in part on the UE request.

20. The apparatus of claim 16, wherein the one or more processors are further configured to:
transmit configuration information that indicates a mapping of one or more bandwidth parts to a set of beamforming modes of the UE, the set of beamforming modes including the first beamforming mode and the second beamforming mode; and
communicate with the UE on a bandwidth part to which the second beamforming mode is mapped.

21. The apparatus of claim 20, wherein the configuration information indicates a mapping of a first set of bandwidth parts to the first beamforming mode of the set of beamforming modes of the UE, and
wherein the configuration information indicates a mapping of a second set of bandwidth parts to the second beamforming mode of the set of beamforming modes of the UE.

22. The apparatus of claim 20, wherein the configuration information indicates a mapping of the one or more bandwidth parts to the digital beamforming mode of the UE, wherein the digital beamforming mode defines a number of inputs and a number of outputs.

23. The apparatus of claim 20, wherein the mapping of the one or more bandwidth parts to the set of beamforming modes of the UE comprises:
a first mapping of the first beamforming mode to a first bandwidth part,
wherein the first beamforming mode is associated with a first power consumption rate, and
wherein the first bandwidth part has a first frequency bandwidth; and
a second mapping of the second beamforming mode to a second bandwidth part,
wherein the second beamforming mode is associated with a second power consumption rate that is lower than the first power consumption rate, and
wherein the second bandwidth part has a second frequency bandwidth that is larger than the first frequency bandwidth.

24. The apparatus of claim 20, wherein the mapping of the one or more bandwidth parts to the set of beamforming modes of the UE comprises:
a first mapping of the first beamforming mode to a first bandwidth part,
wherein the first beamforming mode is associated with a first power consumption rate, and
wherein the first bandwidth part has a first frequency; and
a second mapping of the second beamforming mode to a second bandwidth part,
wherein the second beamforming mode is associated with a second power consumption rate that is lower than the first power consumption rate, and
wherein the second bandwidth part has a second frequency that is higher than the first frequency.

25. The apparatus of claim 16, wherein the one or more processors are further configured to:
receive a UE request to use the second beamforming mode,
wherein the configuration information is based at least in part on the UE request to use the second beamforming mode.

26. The apparatus of claim 16, wherein the second beamforming mode is based at least in part on one or more of:
a power state of the UE,
a signal to interference plus noise ratio of one or more signals received by the UE, or
a signal to interference plus noise ratio of one or more signals received by a base station.

27. A method of wireless communication performed by a user equipment (UE), comprising:
receiving a request to switch from a first beamforming mode to a second beamforming mode, wherein one of the first beamforming mode and the second beamforming mode is a digital beamforming mode, and wherein the other of the first beamforming mode and the second beamforming mode is a hybrid beamforming mode or an analog beamforming mode; and
performing a communication using the second beamforming mode.

28. The method of claim 27, wherein receiving the request is based at least in part on a channel condition associated with the UE

29. The method of claim 27, wherein receiving the request is based at least in part on a power condition associated with the UE.

30. A method of wireless communication performed by a base station, comprising:
transmitting a request to a user equipment (UE) indicating to switch from a first beamforming mode to a second beamforming mode, wherein one of the first beamforming mode and the second beamforming mode is a digital beamforming mode, and wherein the other of the first beamforming mode and the second beamforming mode is an analog beamforming mode or a hybrid beamforming mode; and
transmitting, to the UE, configuration information configuring the UE to switch from the first beamforming mode to the second beamforming mode.
